(19) United States
(12) Patent Application Publication
(10) Pub. No.: US 2017/0366413 A1
(43) Pub. Date: Dec. 21, 2017

(54) NETWORK EVALUATION PROGRAM, NETWORK EVALUATION METHOD, AND NETWORK EVALUATION DEVICE

(71) Applicant: FUJITSU LIMITED, Kawasaki-shi (JP)

(72) Inventor: Taketoshi Yoshida, Kunitachi (JP)

(73) Assignee: FUJITSU LIMITED, Kawasaki-shi (JP)

(21) Appl. No.: 15/613,319

(22) Filed: Jun. 5, 2017

(30) Foreign Application Priority Data
Jun. 21, 2016 (JP) 2016-122473

(51) Int. Cl. H04L 12/24; H04L 12/26; G06F 9/455

(52) U.S. Cl. CPC H04L 41/145; H04L 43/0888; H04L 43/50; G06F 2009/45591; G06F 2009/45579; G06F 2201/815

(57) ABSTRACT

A non-transitory computer-readable storage medium storing therein a network evaluation program for causing a computer to execute a process comprising deploying, in each physical machine of a system in which one or more physical machines and one or more physical storage devices are connected via a physical path, a first virtual machine to execute software of applying a steady access load with respect to the physical storage device or a second virtual machine to execute software of applying a fluctuating access load with respect to the physical storage device, and identifying a plurality of the virtual machines that share a same physical path, based on a measurement result of throughput for a case where at least one or more of the second virtual machines and one or more of the first virtual machines have been executed in a same time period.

### CROSS-REFERENCE TO RELATED APPLICATION

This application is based upon and claims the benefit of priority of the prior Japanese Patent Application No. 2016-122473, filed on Jun. 21, 2016, the entire contents of which are incorporated herein by reference.

### FIELD

The present invention relates to a network evaluation program, a network evaluation method, and a network evaluation device.

### BACKGROUND

There are information processing systems in which a plurality of physical machines (hereinafter also referred to as physical servers) and a plurality of physical storage devices are connected over a network. In such information processing systems, a virtual storage or a virtual machine is deployed with respect to the physical machine. A virtual storage is associated with the physical area of the physical storage device.

In the case where the virtual machine accesses the virtual storage, the virtual machine accesses the physical area of the physical storage device over a physical path, such as a local area network (LAN) cable. In the case where a plurality of the virtual machines access the physical storage device over the same physical path, the bandwidth of the physical path is shared.

In each virtual machine, the bandwidth demanded for communication with the physical storage device is set. Therefore, upon deployment of the virtual machine, an administrator of the information processing system deploys the virtual machine in the physical server that is able to reliably provide the demanded bandwidth.

A technique relating to the evaluation of the physical server is described in, for example, Japanese Laid-open Patent Publication No. 2014-139845.

### SUMMARY

However, there are cases where the physical path over which the virtual machine accesses the physical storage device is not detectable. For the administrator, in such cases, communications for which the bandwidth of the physical path is shared are not identifiable, and the physical server that is able to reliably provide the bandwidth demanded for the virtual machine is not determinable. Therefore, cases occur where the virtual machine is deployed beyond the bandwidth of the physical path, and there are cases where the service level agreement (SLA) is not able to be met.

A non-transitory computer-readable storage medium storing therein a network evaluation program for causing a computer to execute a process comprising:

deploying, in each physical machine of a system in which one or more physical machines and one or more physical storage devices are connected via a physical path, a first virtual machine to execute software of applying a steady access load with respect to the physical storage device or a second virtual machine to execute software of applying a fluctuating access load with respect to the physical storage device; and

identifying a plurality of the virtual machines that share a same physical path, based on a measurement result of throughput for a case where at least one or more of the second virtual machines and one or more of the first virtual machines have been executed in a same time period.

In one aspect, a physical path over which the communication of a virtual machine with respect to a physical storage device is made is able to be managed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an information processing system of this embodiment.

FIG. 2 is a flowchart diagram illustrating the processing flow of the network evaluation program 120 in this embodiment.

FIG. 3 is a diagram illustrating a deployment example of the steady-load virtual machine VM and the fluctuating-load virtual machine VM.

FIG. 4 is a diagram illustrating an example of the measurement results of a case where the fluctuating-load virtual machine VM and the steady-load virtual machine VM do not share the same LAN cable 200.

FIG. 5 is a diagram illustrating an example of the measurement results of a case where the fluctuating-load virtual machine VM and the steady-load virtual machine VM share the same LAN cable 200.

FIG. 6 is a diagram illustrating an example of the measurement results of a case where the fluctuating-load virtual machine VM and a plurality of the steady-load virtual machines VM share the same LAN cable 200.

FIG. 7 is a hardware configuration diagram of a network evaluation device 100 in a second embodiment.

FIG. 8 is a diagram illustrating the functions of software of the network evaluation device 100 illustrated in FIG. 7.

FIG. 9 is a flowchart diagram illustrating the processing flow of the network evaluation program 120 in the second embodiment.

FIG. 10 is a flowchart diagram illustrating the processing of step S21 in FIG. 9.

FIG. 11 is a diagram illustrating an example of the physical server PM selected in accordance with the method 1.

FIG. 12 is a diagram illustrating an example of the physical server PM selected in accordance with the method 2.

FIG. 13 is a flowchart diagram illustrating the processing of step S33 in FIG. 10 in accordance with the method 1.

FIG. 14 is a flowchart diagram illustrating the processing of step S43 in FIG. 13.

FIG. 15 is a diagram illustrating an example of the measured-load-value table 122-1.

FIG. 16 is a diagram illustrating a calculation example for the similarity.

FIG. 17 is a diagram illustrating an example of a shared-bandwidth management table 121-1 created in step S46 of FIG. 13.

FIG. 18 is a flowchart diagram illustrating the processing of step S33 in FIG. 10 in accordance with the method 2.

FIG. 19 is a diagram illustrating an example of a measured-load-value table 122-2 created in step S55.

FIG. 20 is a diagram illustrating a calculation example for the similarity.

FIG. 21 is a diagram illustrating an example of a shared-bandwidth management table 121-2 created in step S56 of FIG. 18.

FIG. 22 is a flowchart diagram illustrating the processing of step S22 in FIG. 9.

FIG. 23 is a diagram illustrating an example of the processing in step S64.

FIG. 24 is a diagram illustrating an example of the processing in step S65.

FIG. 25 is a flowchart diagram illustrating the processing of step S23 in FIG. 9.

FIG. 26 is a diagram schematically illustrating the processing of step S23, described with the flowchart diagram in FIG. 25.

FIG. 27 is a flowchart diagram illustrating the processing of step S24 in FIG. 9.

FIG. 28 is a diagram schematically illustrating the processing of step S24, described with the flowchart diagram in FIG. 27.

FIG. 29 is a flowchart diagram illustrating the details of the processing of step S25 in FIG. 9.

FIG. 30 is a diagram schematically illustrating the processing of step S25.

FIG. 31 is a diagram illustrating the number of actions taken for the identification of the sharing relationship.

FIG. 32 is a diagram illustrating an example of the access loads and the measurement results of the first and second fluctuating-load virtual machines VM.

FIG. 33 is a diagram illustrating an example of the access load and the measurement result of the steady-load virtual machine VM.

### DESCRIPTION OF EMBODIMENTS

Embodiments will be described hereinafter according to the drawings. However, it is noted that the technical scope is not limited to the embodiments described below, but covers the matters described in the claims and the equivalents thereof.

### Information Processing System

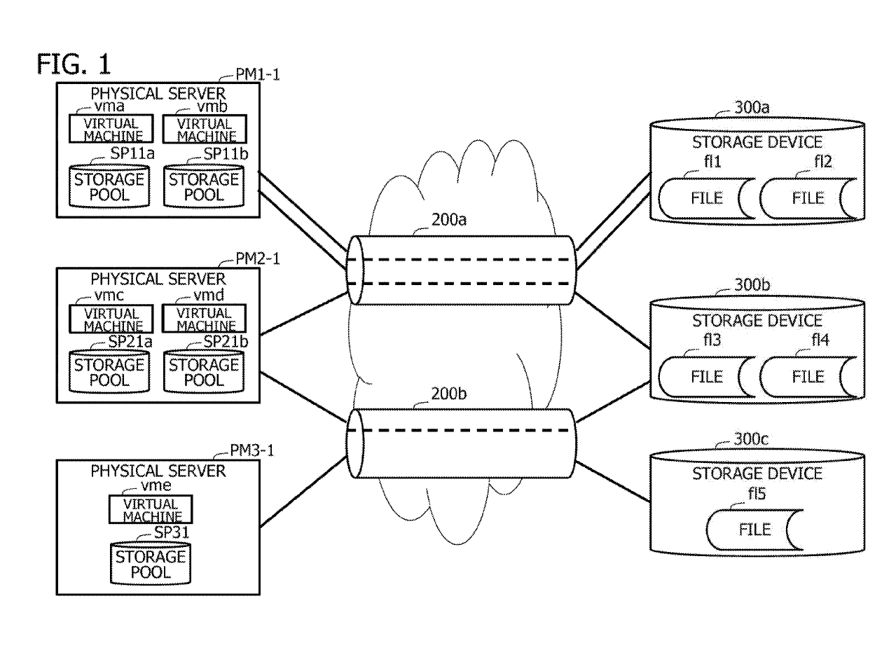

FIG. 1 is a diagram illustrating an example of an information processing system of this embodiment. The information processing system is, for example, a system in a data center. FIG. 1 illustrates an example of a case where the information processing system includes three physical machines PM1-1, PM2-1, and PM3-1 (hereinafter also referred to as physical servers PM) and three physical storage devices 300a, 300b, and 300c (hereinafter also referred to as storage devices 300). The example of FIG. 1 is not limiting, and the information processing system may include a large number of the physical servers PM and a large number of the storage devices 300.

The storage device 300 includes a large number of physical storage devices aligned in an array, for example. The storage device 300 is a storage device such as, for example, a network attached storage (NAS) or a storage area network (SAN). In the storage device 300, files f11 to f15 (also referred to as file f1) are stored.

The physical server PM is, for example, a computer including a server function. Although not illustrated in the drawing, the physical server PM includes a central processing unit (CPU), a memory, and the like. In the respective physical servers PM, one or a plurality of virtual machines vma to vme (hereinafter also referred to as virtual machine vm) are deployed, for example.

On each virtual machine vm, a program of an operation system or various types of application programs are run. The virtual machine vm performs, for example, application processing or the like in accordance with an application program. Specifically, on the physical server PM1-1 illustrated in FIG. 1, the two virtual machines vma and vmb are run. On the physical server PM2-1, the two virtual machines vmc and vmd are run. On the physical server PM3-1, one virtual machine vme is run.

In the physical server PM, storage pools SP11a, SP11b, SP21a, SP21b, and SP31 (hereinafter also referred to as storage pools SP) are deployed as virtual storage. Specifically, in the physical server PM1-1, the storage pools SP11a and SP11b are deployed. In the physical server PM2-1, the storage pools SP21a and SP21b are deployed. In the physical server PM3-1, the storage pool SP31 is deployed.

The storage pool SP is a virtual volume associated with the storage device 300. In the storage pool SP, an allocatable area out of a physical storage area of the storage device 300 is registered in units of logical storage areas (hereinafter referred to as logical volumes). With the logical volume, the physical storage area storing the file f1 is associated.

The virtual machine vm accesses the storage pool SP as storage. In the case of accessing the file f1, the virtual machine vm accesses the storage device 300 storing the file f1, via the storage pool SP.

The storage pool SP and the storage device 300 are connected via a network. In this embodiment, the network includes a path that is a signal line (physical path), such as a local area network (LAN) cable or an optical cable. In this embodiment, a case is illustrated as an example where LAN cables 200a and 200b (hereinafter also referred to as LAN cables 200) are used for the communication path of the storage pool SP and the storage device 300.

In this manner, upon the virtual machine vm accessing the storage pool SP, the virtual machine vm connects with the storage device 300 over the LAN cable 200 to perform an access (reading, writing, or the like) with respect to the physical storage area.

(Sharing of LAN Cable 200)

According to the example of FIG. 1, one LAN cable 200 is shared for the communications by the plurality of virtual machines vm. Specifically, the LAN cable 200a is shared for the communications by the three virtual machines vma, vmb, and vmc. Therefore, the bandwidth of the LAN cable 200a is shared for the communications by the three virtual machines vma, vmb, and vmc. In the case where one LAN cable 200 is shared by the plurality of virtual machines vm, the bandwidth that one virtual machine vm is able to use is reduced.

The LAN cable 200b is shared for the communications by the two virtual machines vmd and vme. Therefore, the bandwidth of the LAN cable 200B is shared for the communications by the two virtual machines vmd and vme.

(Deployment of Virtual Machine)

An administrator of a data center deploys the virtual machine vm in accordance with the state of deployment of the storage pool SP, upon construction of the information processing system. The bandwidth demanded for the communication with the storage device 300 is set for the virtual machine vm, and the administrator deploys the virtual machine vm in the physical server PM that is able to reliably provide the demanded bandwidth.

The LAN cable 200 over which the communication by the virtual machine vm with the storage device 300 is made is set for each storage pool SP. Thus, the administrator deploys the virtual machine vm in the physical server PM with the deployed storage pool SP for which a path is set such that the total of bandwidths of the virtual machines vm sharing the LAN cable 200 does not exceed the bandwidth of the LAN cable 200.

Note that, in the case where the information processing system employs a cloud network, information inside the network is hidden, and only inputs and outputs are indicated. A cloud network is constructed using a network device, such as a switch or a router, but the topology and communication paths are hidden. Thus, the administrator is not able to detect the physical path over which the communication of the storage pool SP and the storage device 300 is made.

Thus, for the administrator, the virtual machines vm that share the bandwidth of the LAN cable 200 are not identifiable, and the physical server PM that is able to reliably provide the bandwidth demanded for the virtual machine vm is not determinable. Accordingly, cases occur where the virtual machine vm is deployed beyond the bandwidth of the LAN cable 200, and the demanded bandwidth is not able to be met. As a result, there are cases where the SLA of the information processing system is not able to be met.

As such, it is desired that the shared state of the LAN cable 200 be identified, in order to guarantee the performance demanded for the communication by the virtual machine vm with respect to the storage device 300.

### First Embodiment

Thus, a network evaluation program 120 of this embodiment deploys a first virtual machine or a second virtual machine, in each physical machine of a system in which one or more physical machines and one or more physical storage devices are connected via a physical path.

The first virtual machine is a virtual machine to execute software with which a steady access load is applied with respect to the physical storage device. The second virtual machine is a virtual machine to execute software with which a fluctuating access load is applied with respect to the physical storage device. The access load is an access with respect to the physical storage device and is writing or reading of data.

The network evaluation program 120 identifies a plurality of virtual machines that share the same physical path, on the basis of the measurement results of the throughput for a case where at least one or more of the second virtual machines and one or more of the first virtual machines have been executed in the same time period.

The physical machine corresponds to the physical server PM illustrated in FIG. 1, and the physical storage device corresponds to the storage device 300 illustrated in FIG. 1. The physical path is a physical path as a unit for sharing the bandwidth and is a LAN cable, an optical cable, or the like.

Accordingly, the network evaluation program 120 is able to identify the combination of communications of the virtual machines with respect to the physical storage device in which the same physical path is shared. That is, the network evaluation program 120 is able to identify the combination of the virtual machines that share the same physical path for an access to the physical storage device.

Thus, an administrator is able to calculate the total of bandwidths demanded for the communications, with respect to the physical storage device, of the virtual machines that share the physical path. Accordingly, the administrator is able to determine, out of the plurality of physical machines, the physical machine with which the total bandwidth demanded for the plurality of virtual machines sharing the physical path connected with the deployed virtual machines falls within the bandwidth of the physical path. Thus, the administrator is able to determine the physical machine that meets the demanded bandwidth for the virtual machine intended to be deployed. Accordingly, it is possible to guarantee the performance demanded for the virtual storage.

In this manner, the network evaluation program 120 in this embodiment is able to detect the shared state of the physical path, even in the information processing system of which the communication path of the virtual machine and the physical storage device is not disclosed. Thus, on the basis of information of the virtual machines that share the bandwidth, it is possible to manage the physical path over which the communication of the virtual machine with respect to the physical storage device is made. Accordingly, it is possible to meet the SLA demanded for the system.

(Processing Flow of Network Evaluation Program 120)

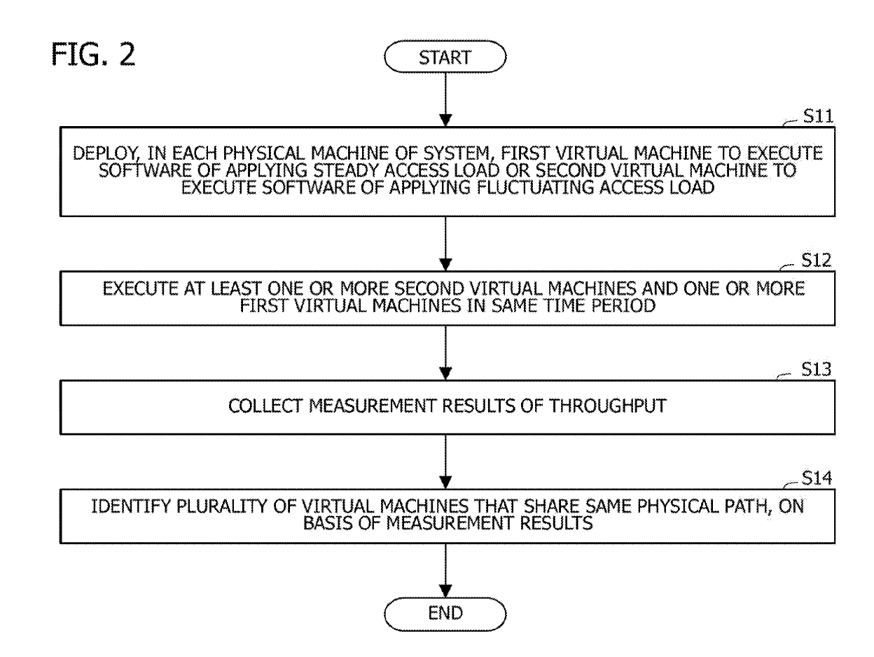

FIG. 2 is a flowchart diagram illustrating the processing flow of the network evaluation program 120 in this embodiment.

S11: The network evaluation program 120 deploys the first virtual machine (hereinafter referred to as steady-load virtual machine VM) or the second virtual machine (hereinafter referred to as fluctuating-load virtual machine VM), in each physical server PM of the system. Hereinafter, the steady-load virtual machine VM and the fluctuating-load virtual machine VM are also referred to as measurement virtual machine VM. The deployed measurement virtual machine VM includes at least one fluctuating-load virtual machine VM.

S12: The network evaluation program 120 executes at least one or more of the steady-load virtual machines VM and one or more of the fluctuating-load virtual machines VM in the same time period.

The network evaluation program 120 executes each measurement virtual machine VM for 20 to 30 minutes, for example. During this time, the throughput of the access processing is measured in each measurement virtual machine VM. The throughput indicates the amount of access processing per second (in megabytes per second (MB/s)) that is executed with respect to the storage device 300.

S13: The network evaluation program 120 collects the measurement results of the throughput of the access processing from each of the measurement virtual machines VM. The measurement result includes information of the amounts of access processing over a time of, for example, 20 to 30 minutes.

S14: On the basis of the measurement results, the network evaluation program 120 identifies a plurality of the measurement virtual machines VM that share the same physical path. The network evaluation program 120 identifies, for example, the combination of the steady-load virtual machine VM and the fluctuating-load virtual machine VM having a correlation in the measurement results, as a plurality of the measurement virtual machines VM that share the same physical path.

### Deployment Example of Measurement Virtual Machine VM

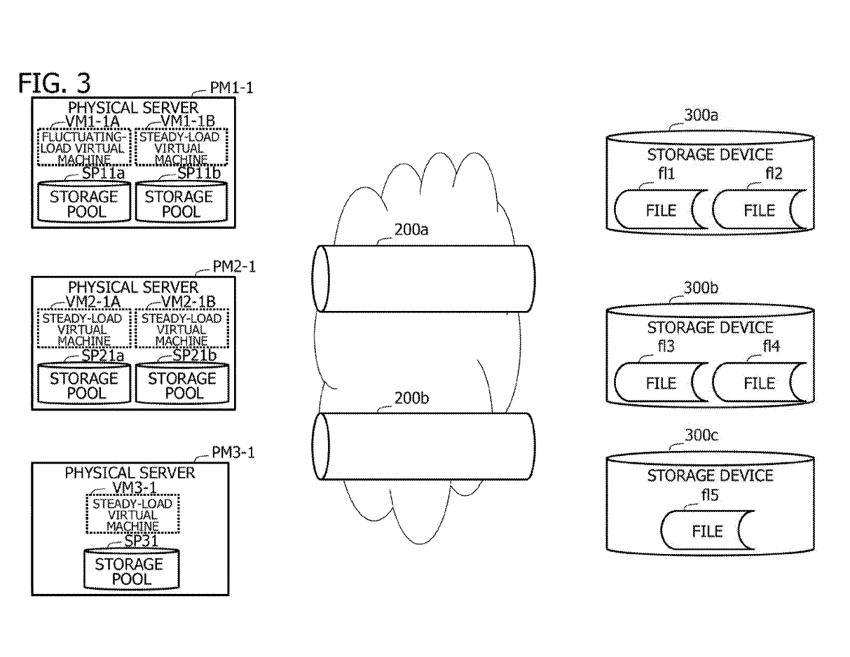

FIG. 3 is a diagram illustrating a deployment example of the steady-load virtual machine VM and the fluctuating-load virtual machine VM. In FIG. 3, those that are the same as those illustrated in FIG. 1 are indicated by the same reference signs. Although not illustrated in FIG. 3, a network evaluation device in this embodiment is connected with each physical server PM.

In the example of FIG. 3, the network evaluation program 120 deploys a fluctuating-load virtual machine VM1-1A and a steady-load virtual machine VM1-1B with respect to the physical server PM1-1, upon construction of the system. The communication path to and from the storage device 300 is set for each storage pool SP. Thus, the network evaluation program 120 deploys the measurement virtual machine VM for each storage pool SP.

In the example of FIG. 3, the network evaluation program 120 deploys two steady-load virtual machines VM2-1A and VM2-1B in the physical server PM2-1 and one steady-load virtual machine VM3-1 in the physical server PM3-1. As illustrated in FIG. 3, at least one out of the deployed measurement virtual machines VM is the fluctuating-load virtual machine VM. Note that this example is not limiting, and a plurality of the fluctuating-load virtual machines VM may be deployed.

The network evaluation program 120 collects the measurement results of the throughput for a case where the measurement virtual machines VM have been executed in the same time period. On the basis of the correlation of the measurement results, the network evaluation program 120 identifies the combination of the fluctuating-load virtual machine VM and the steady-load virtual machine VM that share the same LAN cable 200.

### Example of Measurement Result

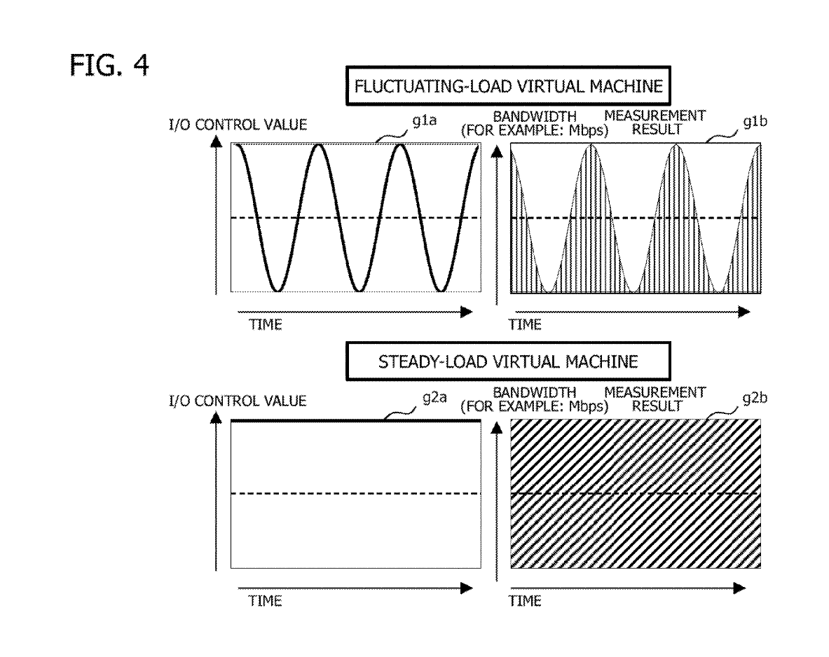

With reference to FIGS. 4 to 6, an example of the measurement results of the throughput of the fluctuating-load virtual machine VM and the steady-load virtual machine VM will be described.

(Case where Sharing Relationship is Absent)

FIG. 4 is a diagram illustrating an example of the measurement results of a case where the fluctuating-load virtual machine VM and the steady-load virtual machine VM do not share the same LAN cable 200. Two graphs g1a and g1b in the upper part in FIG. 4 indicate graphs of the fluctuating-load virtual machine VM, and two graphs g2a and g2b in the lower part indicate graphs of the steady-load virtual machine VM.

The graph g1a illustrates the change in the access load applied by the fluctuating-load virtual machine VM. The access load indicates the amount of access processing such as reading or writing executed with respect to the storage device 300 and is represented as an I/O control value. The abscissa of the graph g1a indicates the time, and the ordinate the I/O control value.

As illustrated in the graph g1a, the amount of access processing applied by the fluctuating-load virtual machine VM fluctuates. The amount of access processing applied by the fluctuating-load virtual machine VM fluctuates cyclically between the maximum value and the minimum value of the access processing. Note that this example is not limiting, and it is not that the change in the access load applied by a fluctuating-load tool has to have a cycle.

The graph g2a illustrates the change in the access load applied by the steady-load virtual machine VM. The abscissa of the graph g2a indicates the time, and the ordinate the I/O control value. As illustrated in the graph g2a, the amount of access processing applied by the steady-load virtual machine VM is steady (constant) and is at the maximum value of the access processing.

The graph g1b illustrates the change in the throughput of the access processing measured by the fluctuating-load virtual machine VM, and the graph g2b illustrates the change in the throughput of the access processing measured by the steady-load virtual machine VM. The abscissas of the graphs g1b and g2b are the time, and the ordinates are the measured value of the throughput (in megabits per second (Mbps)).

FIG. 4 illustrates a case where the same LAN cable 200 is not shared between the fluctuating-load virtual machine VM and the steady-load virtual machine VM. Thus, the measured value of the fluctuating-load virtual machine VM (in the graph g1b) is not subject to the influence of the access load applied by the steady-load virtual machine VM (in the graph g2a) and changes in a similar manner to the applied access load (in the graph g1a). The measured value of the steady-load virtual machine VM (in the graph g2b) is not subject to the influence of the access load applied by the fluctuating-load virtual machine VM (in the graph g1a) and remains constant.

In this manner, in the case where the fluctuating-load virtual machine VM and the steady-load virtual machine VM do not share the same LAN cable 200, the measured value of the fluctuating-load virtual machine VM (in the graph g1b) and the measured value of the steady-load virtual machine VM (in the graph g2b) do not have a correlation.

(Case where Sharing Relationship is Present)

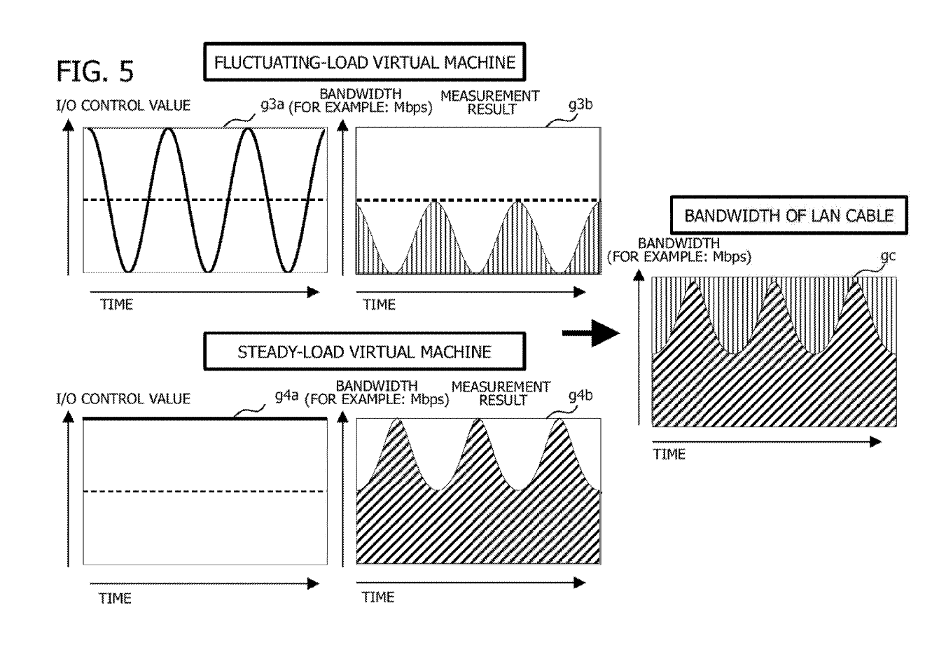

FIG. 5 is a diagram illustrating an example of the measurement results of a case where the fluctuating-load virtual machine VM and the steady-load virtual machine VM share the same LAN cable 200. Two graphs g3a and g3b in the upper left in FIG. 5 indicate graphs of the fluctuating-load virtual machine VM, and two graphs g4a and g4b in the lower left indicate graphs of the steady-load virtual machine VM.

The graph g3a illustrates the change in the access load applied by the fluctuating-load virtual machine VM, in a similar to the graph g1a in FIG. 4. The graph g4a illustrates the change in the access load applied by the steady-load virtual machine VM, in a similar to the graph g2a in FIG. 4. The graph g3b illustrates the measured value of the fluctuating-load virtual machine VM, and the graph g4b illustrates the measured value of the steady-load virtual machine VM.

FIG. 5 illustrates a case where the same LAN cable 200 is shared between the fluctuating-load virtual machine VM and the steady-load virtual machine VM. Thus, the measured value of the fluctuating-load virtual machine VM (in the graph g3b) is subject to the influence of the access load applied by the steady-load virtual machine VM (in the graph g4a) and becomes half the value of the measured value of the case where sharing is absent. The measured value of the steady-load virtual machine VM (in the graph g4b) fluctuates in accordance with the access load applied by the fluctuating-load virtual machine VM (in the graph g3a).

Specifically, as illustrated in the graph g4b, the measured value of the steady-load virtual machine VM drops when the access load applied by the fluctuating-load virtual machine VM rises. The measured value of the steady-load virtual machine VM rises when the access load applied by the fluctuating-load virtual machine VM drops. In this manner, in the case where the fluctuating-load virtual machine VM and the steady-load virtual machine VM share the same LAN cable 200, the measurement result of the fluctuating-load virtual machine VM and the measurement result of the steady-load virtual machine VM have a correlation.

A graph gc illustrates the state of use of the bandwidth of the LAN cable 200, for the communication by each measurement virtual machine VM. As illustrated in the graph gc, the total of the measured values coincides with the maximum bandwidth of the LAN cable 200, in the case where only the fluctuating-load virtual machine VM and the steady-load virtual machine VM share the same LAN cable 200.

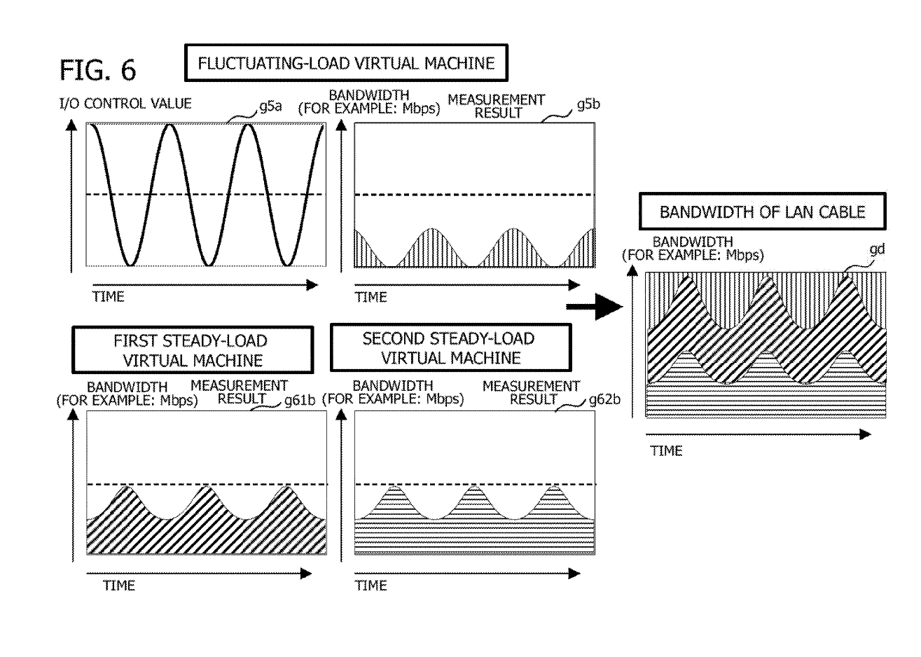

FIG. 6 is a diagram illustrating an example of the measurement results of a case where the fluctuating-load virtual machine VM and a plurality of the steady-load virtual machines VM share the same LAN cable 200. Two graphs g5a and g5b in the upper left in FIG. 6 indicate graphs of the fluctuating-load virtual machine VM. Two graphs g61b and g62b in the lower left indicate graphs of the measured values of first and second steady-load virtual machines VM.

The graph g5a illustrates the change in the access load applied by the fluctuating-load virtual machine VM, in a similar to the graphs g1a and g3a in FIGS. 4 and 5. The graph g5b illustrates the measured value of the fluctuating-load virtual machine VM. The graph g61b illustrates the measured value of the first steady-load virtual machine VM, and the graph g62b illustrates the measured value of the second steady-load virtual machine VM.

FIG. 6 illustrates a case where the same LAN cable 200 is shared between the fluctuating-load virtual machine VM and the first and second steady-load virtual machines VM. Thus, the measured value of the fluctuating-load virtual machine VM (in the graph g5b) is subject to the influence of the access load applied by the first and second steady-load virtual machines VM and becomes ⅓ the value of the measured value of the case where sharing is absent.

The measured values of the first and second steady-load virtual machines VM (in the graphs g61b and g62b) fluctuate in accordance with the access load applied by the fluctuating-load virtual machine VM (in the graph g5a). Therefore, the measurement result of the fluctuating-load virtual machine VM and each of the measurement results of the first and second steady-load virtual machines VM have a correlation.

A graph gd illustrates the state of use of the bandwidth of the LAN cable 200, for the communication by each measurement virtual machine VM. As illustrated in the graph gd, the total of the measured values coincides with the maximum bandwidth of the LAN cable 200, in the case where the fluctuating-load virtual machine VM and the first and second steady-load virtual machines VM share the same LAN cable 200.

As illustrated in FIGS. 4 to 6, the measured values of the steady-load virtual machine VM and the fluctuating-load virtual machine VM have a correlation regardless of the number of the steady-load virtual machines VM, in the case where the steady-load virtual machine VM and the fluctuating-load virtual machine VM share the same LAN cable 200. Thus, the network evaluation program 120 is able to appropriately determine the sharing relationship for the LAN cable 200, on the basis of the correlation of the measured values.

Returning to FIG. 3, the network evaluation program 120 identifies, for example, the fluctuating-load virtual machine VM1-1A and the steady-load virtual machine VM1-1B as the virtual machines VM that share the same LAN cable 200. The network evaluation program 120 identifies the fluctuating-load virtual machine VM1-1A and the steady-load virtual machine VM2-1A as the virtual machines VM that share the same LAN cable 200.

Thus, the network evaluation program 120 identifies the combination of the three measurement virtual machines VM1-1A, VM1-1B, and VM2-1A as the virtual machines VM that share the same LAN cable 200.

The sharing relationship is not determined for the combination of the steady-load virtual machines. Thus, the network evaluation program 120 further deploys a fluctuating-load virtual machine (not illustrated) in the physical server PM2-1 and the steady-load virtual machine VM3-1 in the physical server PM3-1. The network evaluation program 120 determines the sharing relationship of the measurement virtual machines VM2-1B and VM3-1 on the basis of the measurement results.

In this manner, the network evaluation program 120 repeats the deployment and identification while changing the physical server PM in which the measurement virtual machine VM is intended to be deployed. Accordingly, the network evaluation program 120 is able to identify the shared state of the LAN cable 200 for the communication of each storage pool SP and the storage device 300.

### Second Embodiment

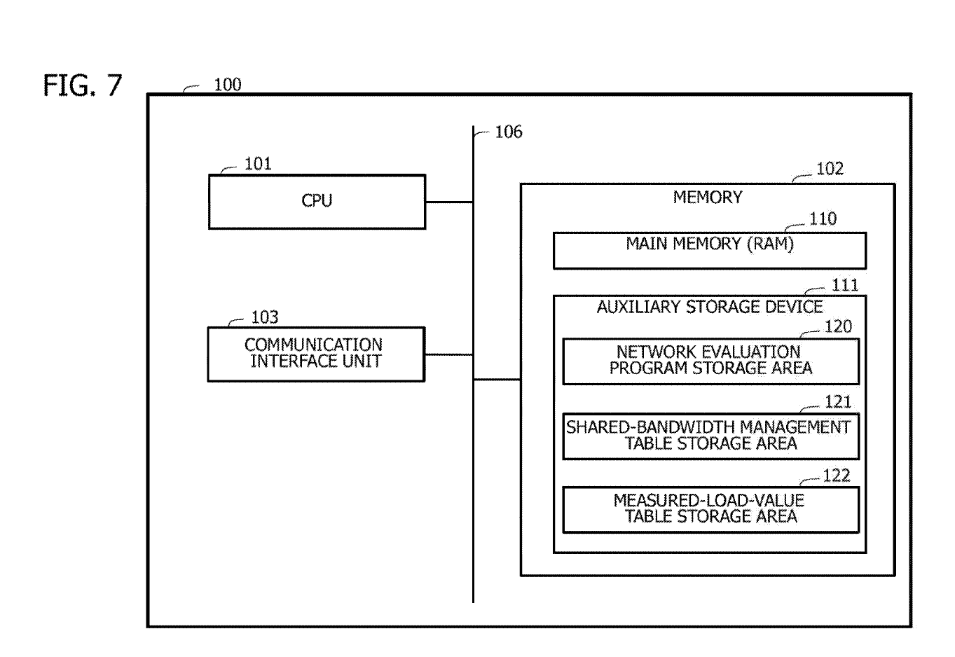

FIG. 7 is a hardware configuration diagram of a network evaluation device 100 in a second embodiment. The network evaluation device 100 includes, for example, a CPU 101, a memory 102 including a main memory 110, an auxiliary storage device 111, and the like, and a communication interface unit 103. The respective units are mutually connected via a bus 106.

The CPU 101 connects with the memory 102 and the like via the bus 106 and performs control of the entire network evaluation device 100. The communication interface unit 103 connects with the physical server PM via a wired communication and performs an exchange of information. The communication interface unit 103 is, for example, a network interface card (NIC).

The main memory 110 indicating a random access memory (RAM) or the like stores data or the like for the CPU 101 to perform processing. The auxiliary storage device 111 includes an area (not illustrated) storing a program of an operation system executed by the CPU 101 and the network evaluation program storage area 120. The auxiliary storage device 111 includes a shared-bandwidth management table storage area 121 and a measured-load-value table storage area 122. The auxiliary storage device 111 indicates a hard disk drive (HDD), a non-volatile semiconductor memory, or the like.

A network evaluation program (hereinafter referred to as network evaluation program 120) in the network evaluation program storage area 120 is loaded to the main memory 110. By the CPU 101 executing the network evaluation program 120 loaded into the main memory 110, the evaluation processing for a network in this embodiment is realized.

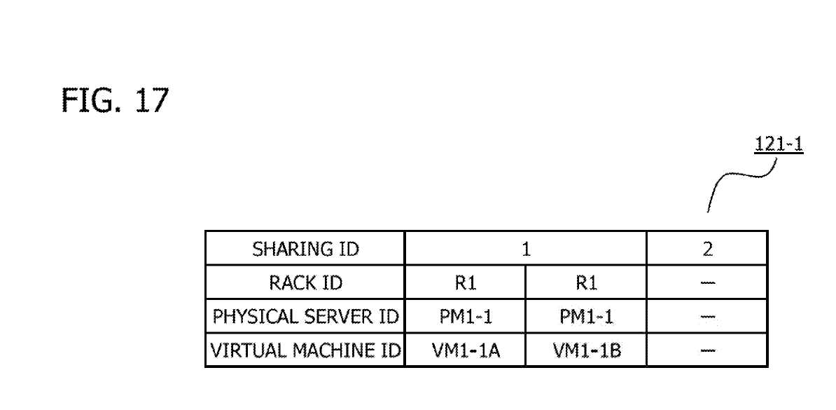

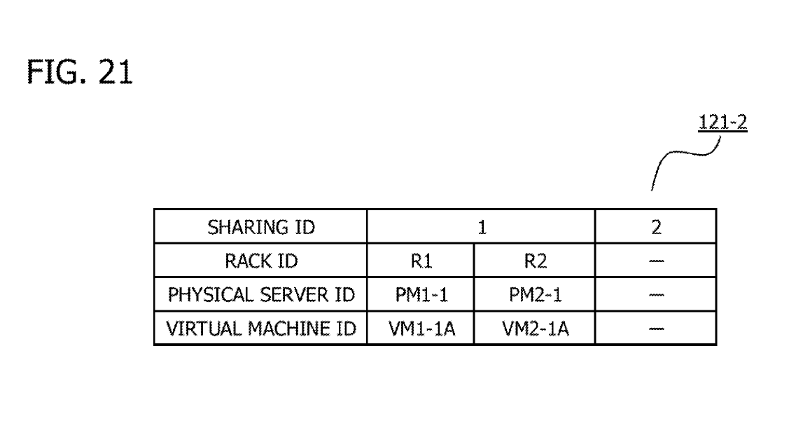

A shared-bandwidth management table (hereinafter referred to as shared-bandwidth management table 121) of the shared-bandwidth management table storage area 121 is a table including information of the sharing relationship identified by the network evaluation program 120. An example of the shared-bandwidth management table 121 will be described later with reference to FIGS. 17 and 21.

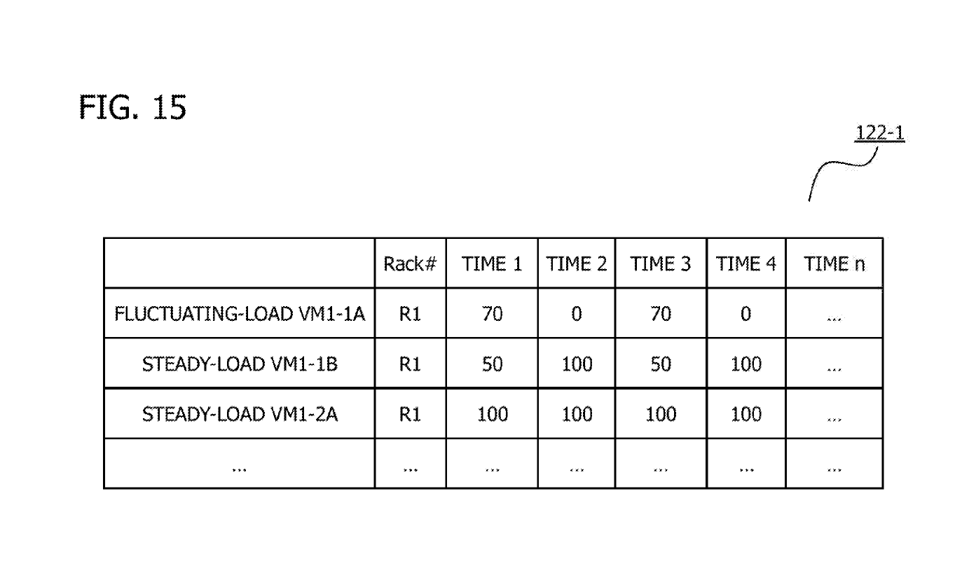

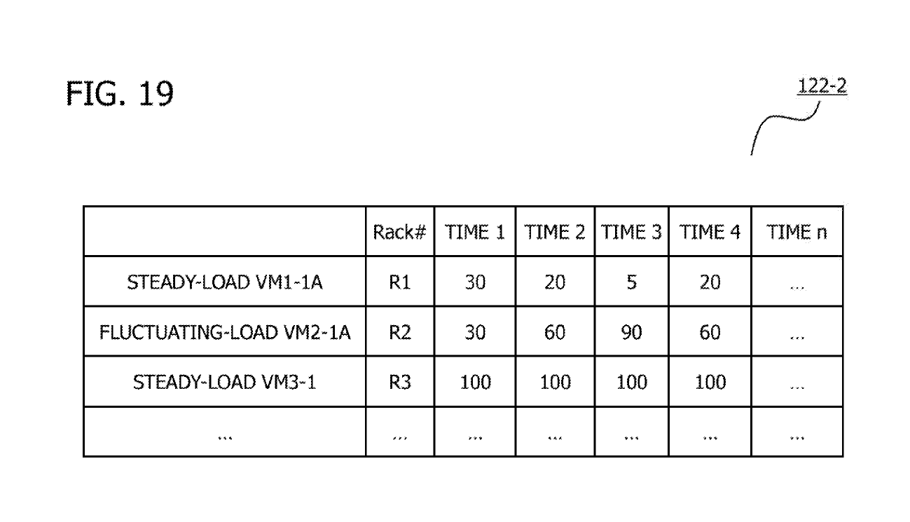

A measured-load-value table (hereinafter referred to as measured-load-value table 122) of the measured-load-value table storage area 122 includes the measurement result of the throughput measured by each measurement virtual machine VM. An example of the measured-load-value table 122 will be described later with reference to FIGS. 15 and 19.

### Function of Software of Network Evaluation Device 100

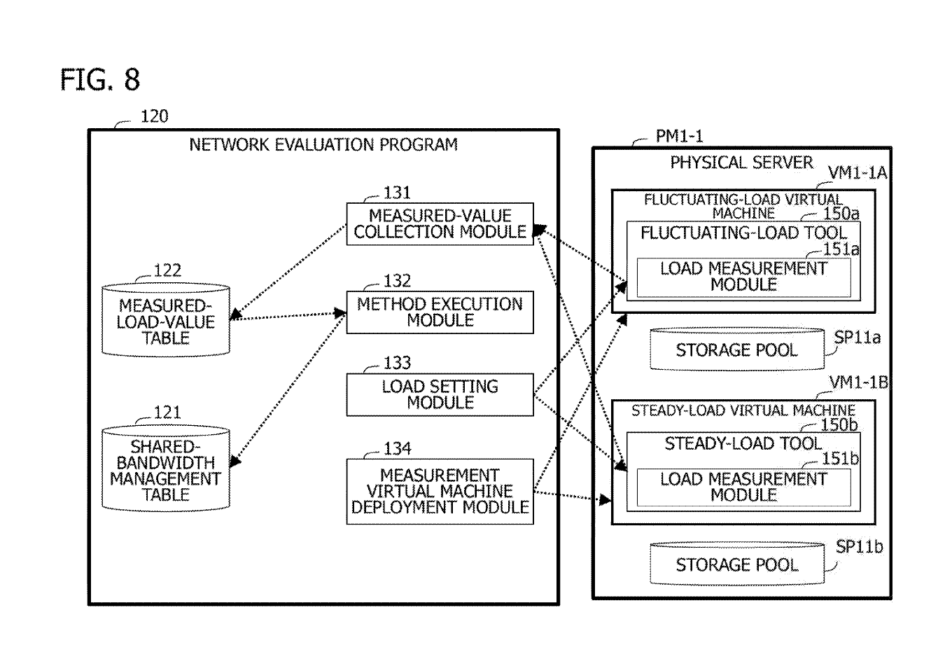

FIG. 8 is a diagram illustrating the functions of software of the network evaluation device 100 illustrated in FIG. 7. In FIG. 8, those that are the same as those illustrated in FIG. 7 are indicated by the same reference signs.

As illustrated in FIG. 8, the network evaluation program 120 includes a measured-value collection module 131, a method execution module 132, a load setting module 133, and a measurement virtual machine deployment module 134.

In accordance with a method, the method execution module 132 selects the physical server PM in which the measurement virtual machine VM is intended to be deployed and instructs the measurement virtual machine deployment module 134 to deploy the measurement virtual machine VM.

The method execution module 132 identifies the measurement virtual machines VM that share the same communication path, on the basis of the measured-load-value table 122 created by the measured-value collection module 131. The method execution module 132 stores the identified sharing relationship in the shared-bandwidth management table 121.

The measurement virtual machine deployment module 134 deploys the measurement virtual machine VM in the physical server PM selected by the method execution module 132. Accordingly, in the physical server PM1-1 in which the storage pools SP11a and SP11b have been deployed, the fluctuating-load virtual machine VM1-1A and the steady-load virtual machine VM1-1B are deployed, for example. FIG. 8 illustrates the physical server PM1-1 as an example, but it is similar for other physical servers PM as well.

On the fluctuating-load virtual machine VM1-1A, a fluctuating-load tool 150a is run. The fluctuating-load tool 150a is, for example, a program that applies an access load fluctuating cyclically in a range between the minimum and maximum access loads, with respect to the storage pool SP. On the steady-load virtual machine VM1-1B, a steady-load tool 150b is run. The steady-load tool 150b is, for example, a program that applies the maximum access load in a steady state, with respect to the storage pool SP.

The fluctuating-load tool 150a and the steady-load tool 150b include load measurement modules 151a and 151b. The load measurement modules 151a and 151b measure and store the throughput of the access processing performed with respect to the storage pool SP.

The load setting module 133 sets the access load value with respect to the fluctuating-load tool 150a and the steady-load tool 150b and gives an instruction to execute the fluctuating-load tool 150a and the steady-load tool 150b. The measured-value collection module 131 collects the measured values measured by the load measurement modules 151a and 151b from each measurement virtual machine VM and stores the collected measured values in the measured-load-value table 122.

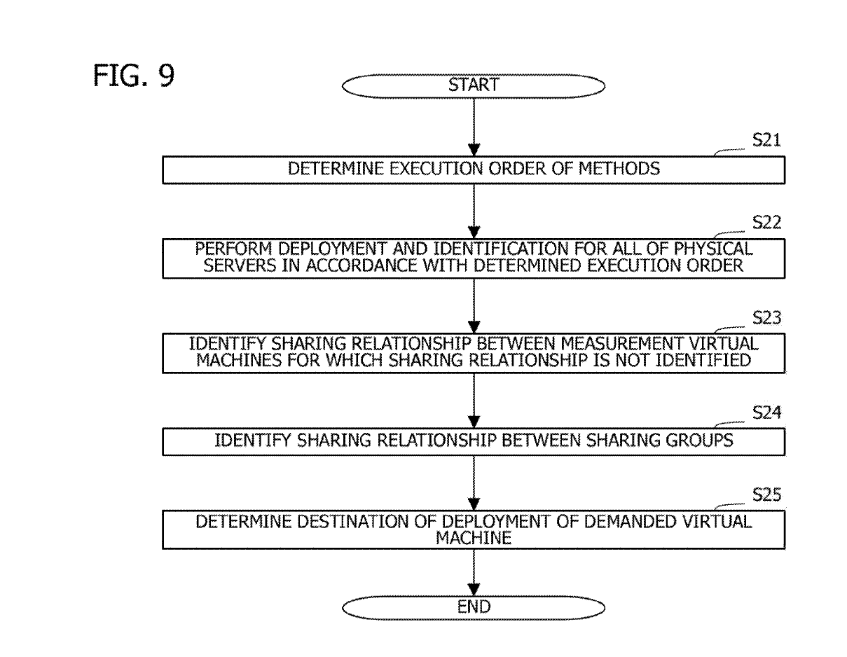

Next, with reference to FIGS. 9 to 30, the processing of the network evaluation program 120 in this embodiment will be described. First, with reference to a flowchart diagram in FIG. 9, the sequence of processing flow of the network evaluation program 120 will be described.

### Processing Flow of Network Evaluation Program 120

FIG. 9 is a flowchart diagram illustrating the processing flow of the network evaluation program 120 in the second embodiment.

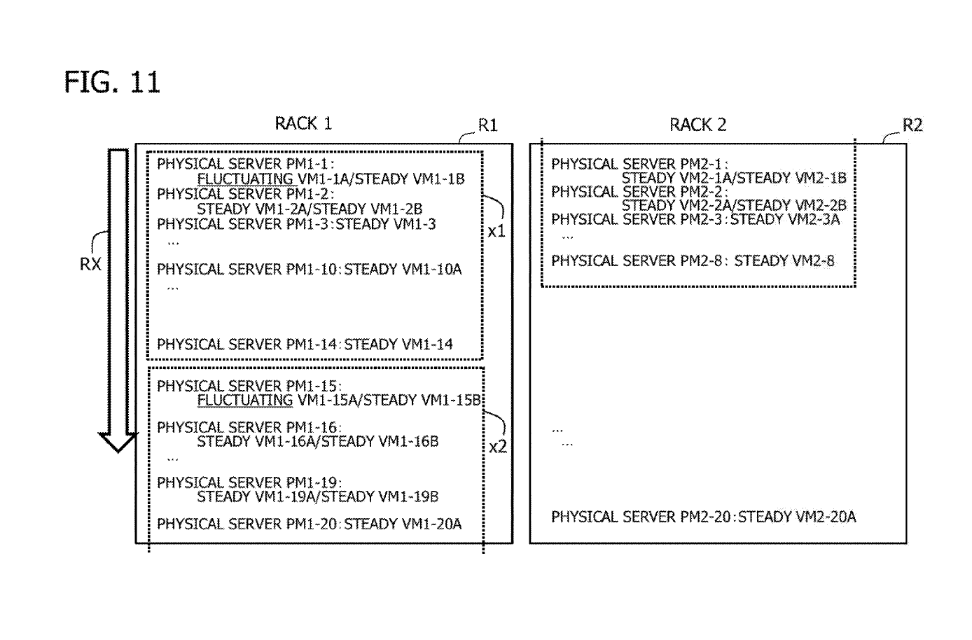

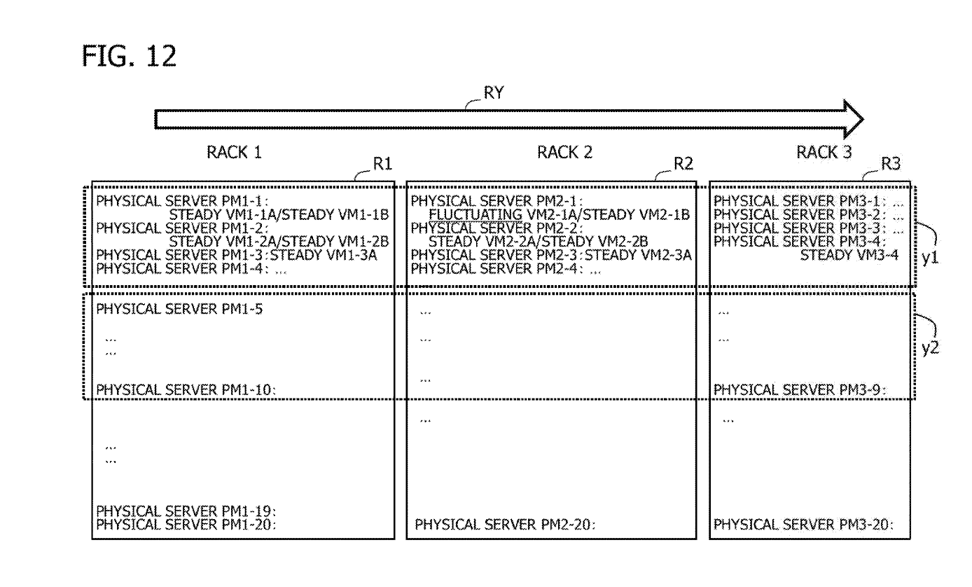

S21: The method execution module 132 determines the execution order of a plurality of methods. The method is a method of selecting the physical server PM in which the measurement virtual machine VM is intended to be deployed, in order to efficiently identify the measurement virtual machines VM that share the same LAN cable 200. In this embodiment, two methods will be illustrated as an example. The details of each method will be described later with reference to FIGS. 11 and 12.

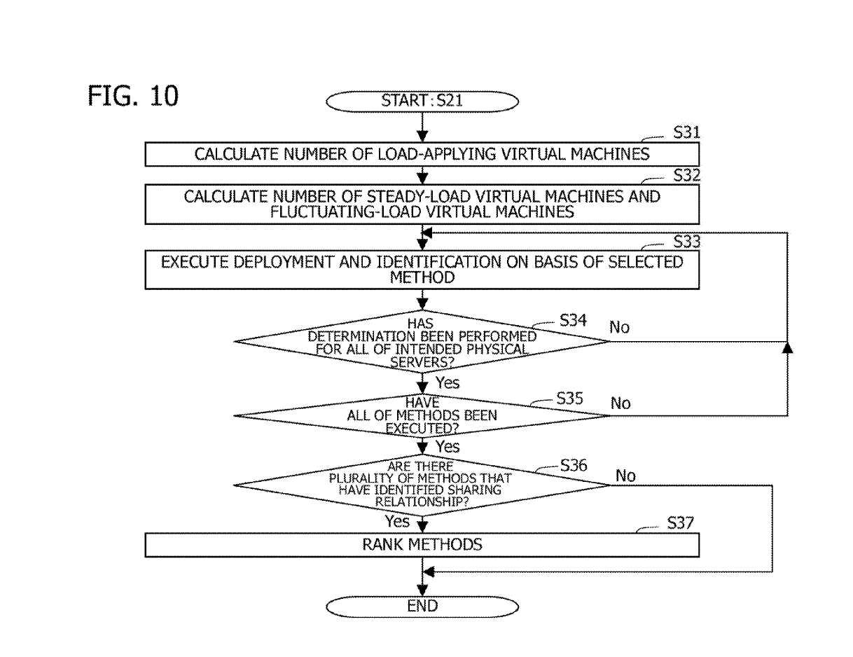

In step S21, the method execution module 132 tests the deployment and identification intended for a part of the physical servers PM, in accordance with each method. On the basis of the test result, the method execution module 132 determines the effectiveness of the method and determines the execution order of the methods. The step of processing in step S21 will be described later with reference to FIGS. 10 to 21.

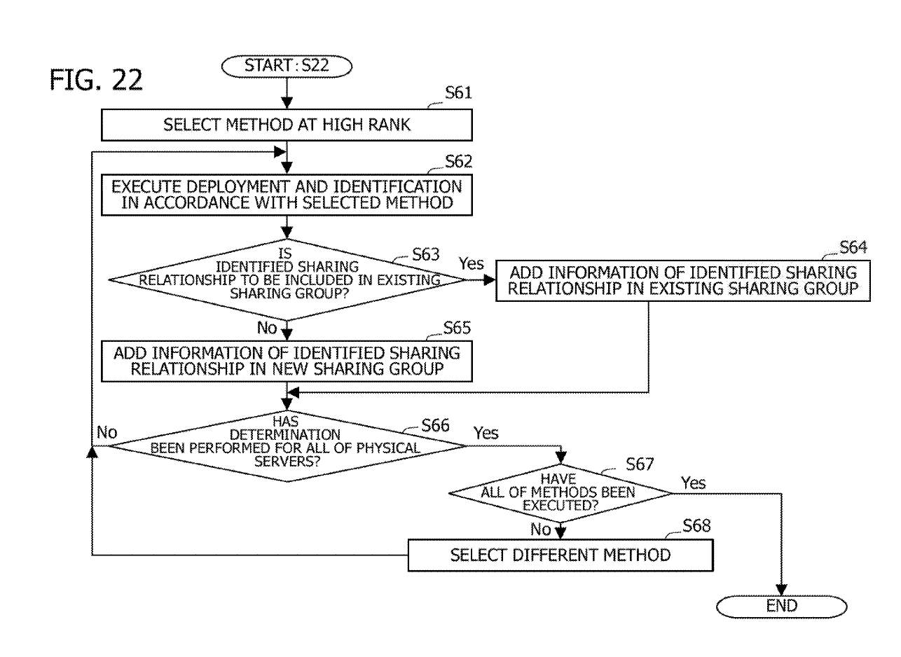

S22: The method execution module 132 performs the deployment and identification thoroughly that are intended for the remaining physical servers PM, in accordance with the method order determined in step S21. The step of processing in step S22 will be described later with reference to FIGS. 22 to 24. After the deployment and identification, the method execution module 132 deletes the deployed measurement virtual machine VM.

The execution of steps S21 and S22 does not promise an exhaustive identification of all of the sharing relationships. Thus, the network evaluation program 120 repeats the re-deployment and identification while changing the physical server PM intended for deployment, in accordance with steps S23 and S24. Accordingly, it is possible to exhaustively identify all of the sharing relationships.

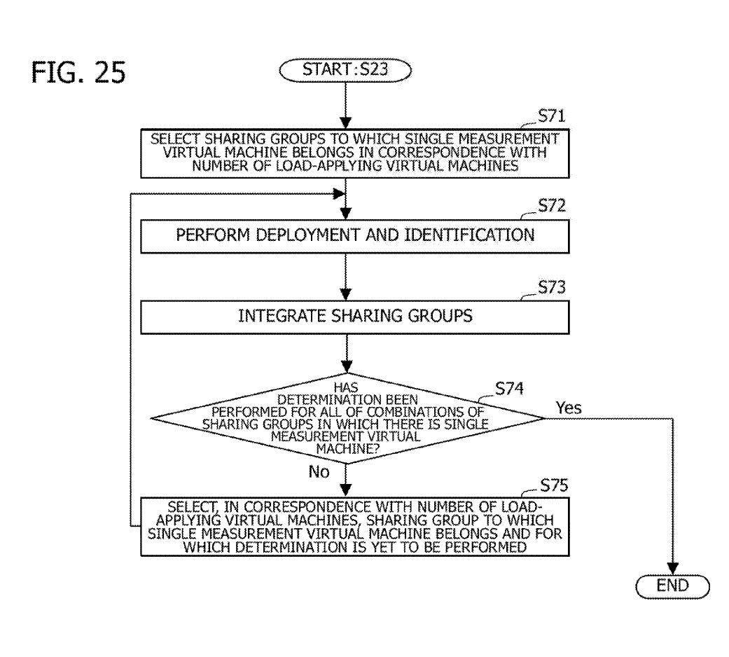

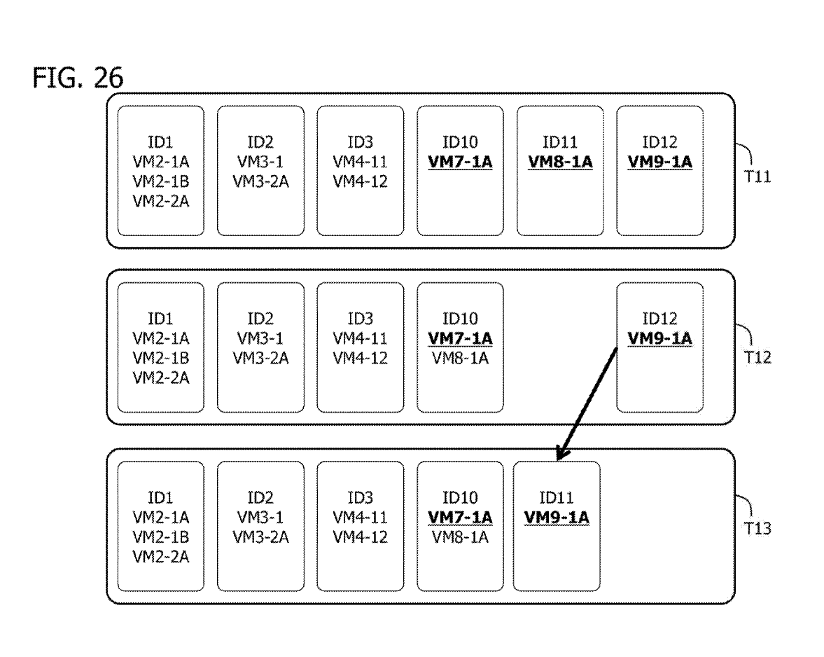

S23: The method execution module 132 performs the re-deployment and identification intended for the measurement virtual machine VM for which the sharing relationship (hereinafter also referred to as sharing group) is not identified. The step of processing in step S23 will be described later with reference to FIGS. 25 and 26.

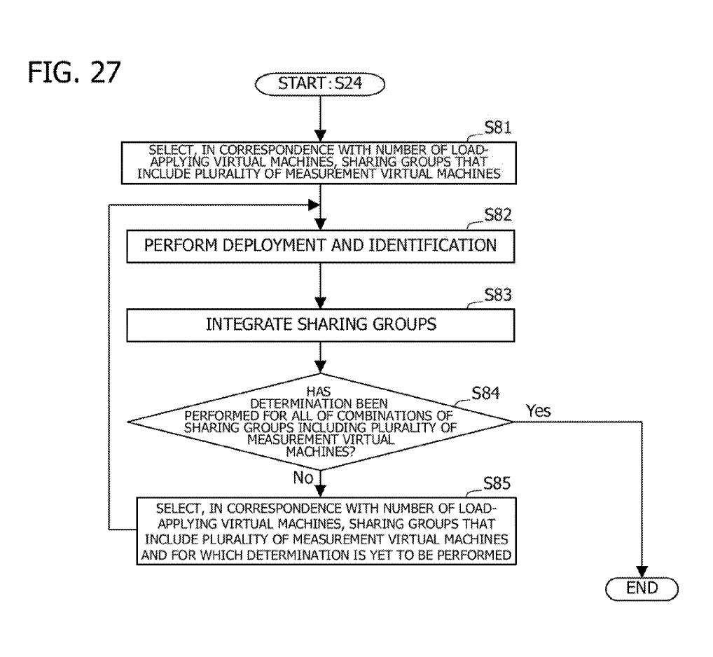

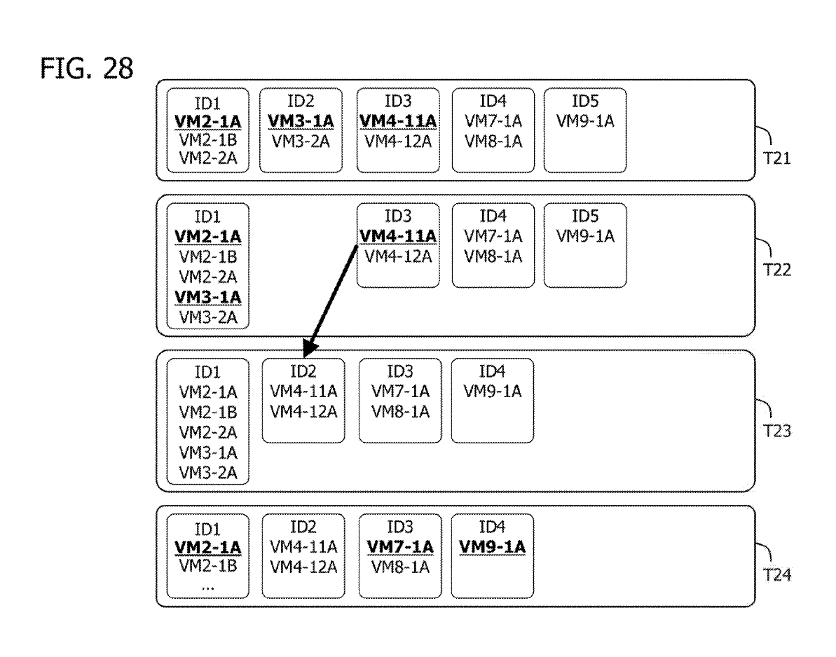

S24: The method execution module 132 identifies the sharing relationship between the identified sharing groups. The step of processing in step S24 will be described later with reference to FIGS. 27 and 28. When all of the sharing relationships are identified, the method execution module 132 deletes each measurement virtual machine VM deployed in the physical server PM.

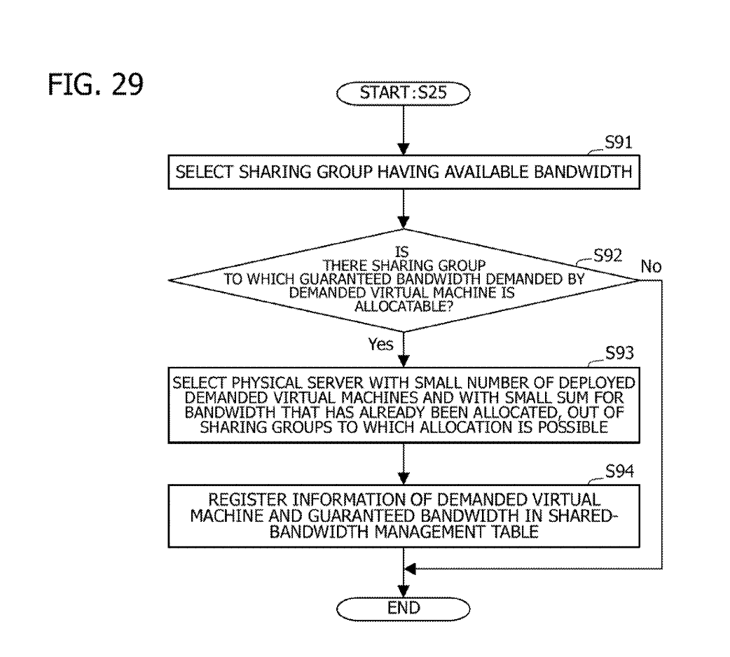

S25: On the basis of the identified sharing group, the method execution module 132 determines the destination of the deployment of the virtual machine (hereinafter also referred to as demanded virtual machine) of which the deployment has been demanded by a user. The step of processing in step S25 will be described later with reference to FIG. 29.

### Step S21 in FIG. 9

FIG. 10 is a flowchart diagram illustrating the processing of step S21 in FIG. 9. As described above, in step S21, the deployment and identification intended for a part of the physical servers PM are tested, in accordance with each method.

In this embodiment, the plurality of physical servers PM are held in a rack (not illustrated). In this embodiment, a case is illustrated as an example where the information processing system includes 10 racks, and each rack holds 20 physical servers PM. In step S21, the physical servers PM are limited to those held in racks R1 to R3, for example, to test the deployment and identification.

S31: The method execution module 132 calculates the number of load-applying virtual machines. The number of the load-applying virtual machines is the number of the virtual machines VM that are deployed in one round of the deployment and identification.

(Number of Load-Applying Virtual Machines)

There are cases where an access load greater than or equivalent to the bandwidth of the LAN cable 200 is not able to be applied with one measurement virtual machine VM. In such cases, the influence of another measurement virtual machine VM on the measurement result is not identifiable. Thus, the method execution module 132 deploys the measurement virtual machines VM in correspondence with the number of the load-applying virtual machines. Note that even if the number of the load-applying virtual machines is a value of the bandwidth of the LAN cable divided by the upper limit of the access load that is able to be applied with one measurement virtual machine VM, there are cases where the influence of the measurement result of another measurement virtual machine VM is not appropriately identifiable, due to a measurement error.

Thus, the method execution module 132 calculates the number of the load-applying virtual machines, in accordance with an expression 1 below. The “bandwidth of physical path” in the expression 1 is the maximum bandwidth that the LAN cable 200 is able to use, and the “coefficient” in the expression 1 is a value adjusted in accordance with the environment. The “measurement error” in the expression 1 is the difference between the measured value of the access that is measured for a case where one measurement virtual machine VM has applied the maximum access load and the maximum access load.

Number of load-applying virtual machines=bandwidth of physical path/(measurement error*coefficient). Expression 1:

For example, a case is illustrated as an example where the bandwidth of the physical path is 10 gigabits per second (Gbps), the coefficient is 4, and the measurement error is 100 MB. The measurement error of 100 MB indicates that, in the case where the maximum access load of 2 gigabytes (GB) has been applied, for example, there is a fluctuation range of 5% (=100 MB) in the measured amount of access. In this case, the method execution module 132 calculates the number of the load-applying virtual machines as 25 (=10 GB/100 MB*4).

In this manner, the method execution module 132 calculates the number of the measurement virtual machines to be deployed, on the basis of the difference between the measured value and the access load for a case where one measurement virtual machine VM has applied the maximum access load and the bandwidth of the physical path 200. Accordingly, the method execution module 132 is able to acquire the number for the deployment with which the influence of the measurement result of another measurement virtual machine VM is made appropriately identifiable. Therefore, it is possible to appropriately identify the measurement virtual machines VM that share the same LAN cable 200.

S32: The method execution module 132 calculates the respective numbers of the steady-load virtual machines VM and the fluctuating-load virtual machines VM. The number of the fluctuating-load virtual machines VM is at least one or more. In this embodiment, a case is illustrated as an example where there is one fluctuating-load virtual machine VM. Thus, in the case where the measurement virtual machines VM are to be deployed in correspondence with 25 as the number of the load-applying virtual machines, for example, the method execution module 132 calculates the number of the fluctuating-load virtual machines VM as 1, and the number of the steady-load virtual machines VM as 24.

This example is not limiting, and a plurality of the fluctuating-load virtual machines VM may be deployed. A case where a plurality of the fluctuating-load virtual machines VM are deployed will be described later as a different embodiment.

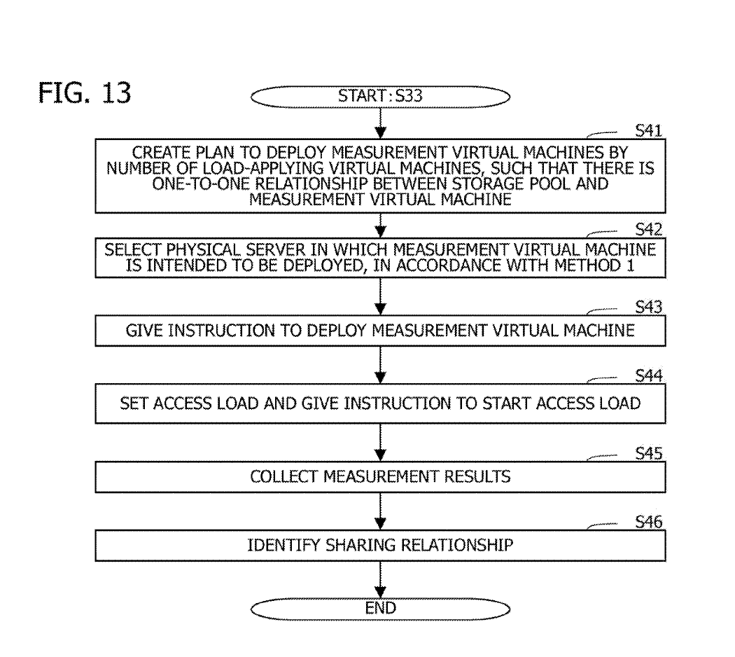

S33: The method execution module 132 selects one method from the plurality of methods and, in accordance with the selected method, performs one round of the deployment and identification of the measurement virtual machine VM. The details of the processing of step S33 will be described later with reference to FIG. 13.

S34: The method execution module 132 determines whether or not the deployment and identification have been performed for all of the physical servers intended to be tested. The method execution module 132 repeats the processing of step S33, until the deployment and identification are completed for all of the physical servers intended to be tested (while No in step S34).

S35: In the case of the deployment and identification having been completed for all of the physical servers intended to be tested (Yes in step S34), the method execution module 132 determines whether or not the processing of steps S33 and S34 has been executed, in accordance with all of the methods. In the case of the executions being incomplete (No in step S35), the method execution module 132 selects a different method and performs the processing of steps S33 and S34.

S36: In the case of the executions having been done in accordance with all of the methods (Yes in step S35), the method execution module 132 determines whether or not there are a plurality of the methods that have identified the sharing relationship. In the case of the sharing relationship having been identified with only one method (No in step S36), the method execution module 132 performs the processing of step S22 (in FIG. 9) using only the method with which the sharing relationship has been identified. Accordingly, the method execution module 132 selects only the method with effectiveness.

S37: In the case of the sharing relationship having been identified with a plurality of the methods (Yes in step S36), the method execution module 132 ranks the methods in descending order of the number of the measurement virtual machines VM for which the sharing relationship has been identified. The method execution module 132 performs the processing of step S22 (in FIG. 9) in the ranked method order. Accordingly, the method execution module 132 allows the deployment and identification to be performed in the method order with which more sharing relationships are identifiable and allows the sharing relationships to be identified efficiently.

In this embodiment, the method execution module 132 gives a ranking, such as “1: Method 1, 2: Method 2,” on the basis of the number of the measurement virtual machines VM for which the sharing relationship has been identified with each method as a result of performing the deployment and identification for the physical servers PM held in the racks R1 to R3.

### Method 1 and Method 2

The methods will be described with reference to FIGS. 11 and 12. As described above, the method is a measure taken to select the physical server PM in which the measurement virtual machine VM is intended to be deployed, in order to allow an efficient identification of the measurement virtual machines VM that share the same LAN cable 200.

(Method 1)

FIG. 11 is a diagram illustrating an example of the physical server PM selected in accordance with the method 1. FIG. 11 illustrates an example of the list of the physical servers PM held in the racks R1 and R2. As illustrated in FIG. 11, the rack R1 holds physical servers PM1-1 to PM1-20, and the rack R2 holds physical servers PM2-1 to PM2-20.

Although not illustrated in the drawing, each physical server PM connects with the LAN cable 200 via a network device, such as a switch or a router. The method execution module 132 assumes that the possibility of the same LAN cable 200 being shared is higher for a plurality of the virtual machines VM connecting with the same network device, relative to a plurality of the virtual machines VM connecting with different network devices. Thus, the method execution module 132 deploys the measurement virtual machine VM preferentially to a plurality of the physical servers PM with the same network devices that the physical servers PM connect to.

In the method 1, the measurement virtual machines VM deployed in the physical servers PM held in the same rack are considered as a plurality of the physical servers PM with the same network device that the physical servers PM connect to. That is, according to the method 1, the plurality of physical servers PM for which the connecting network device is the same include a plurality of the physical servers PM for which the rack (holding device) holding the physical server PM is the same.

According to the example of FIG. 11, the method execution module 132 deploys the measurement virtual machine VM preferentially to, for example, the physical servers PM1-1 to PM1-20 held in the rack R1 (as illustrated by an arrow RX). For example, the method execution module 132 deploys the measurement virtual machines VM in the physical servers PM1-1 to PM1-20 in order from the physical server PM1-1 of which the position within the rack is high or in the opposite order from the physical server PM1-20.

Accordingly, the method execution module 132 is able to deploy the measurement virtual machines VM in the physical servers PM with a high possibility of sharing the same LAN cable 200. Therefore, the method execution module 132 is able to identify the sharing relationship efficiently.

For example, in the case of deploying the measurement virtual machines VM in correspondence with 25 as the number of the load-applying virtual machines, the method execution module 132 deploys the measurement virtual machines VM in the physical servers PM1-1 to PM1-14, as illustrated by a dotted rectangle x1 in FIG. 11. At this time, the method execution module 132 deploys the measurement virtual machine VM for each storage pool. Accordingly, for each storage pool SP, the sharing relationship, for the LAN cable 200, of the measurement virtual machines VM that access the storage pool SP is made identifiable.

In this embodiment, the method execution module 132 deploys one fluctuating-load virtual machine VM. The method execution module 132 deploys the fluctuating-load virtual machine VM in the physical server PM of which the position within the rack is high, for example. The method execution module 132 deploys, for example, the fluctuating-load virtual machine VM1-1A and the steady-load virtual machine VM1-1B to VM1-14.

As illustrated by a dotted rectangle x2, the method execution module 132 upon the second round of the deployment and identification deploys the measurement virtual machines VM with respect to the physical server PM1-15 to PM2-8. It is also similar for the third round of the deployment and thereafter.

(Method 2)

FIG. 12 is a diagram illustrating an example of the physical server PM selected in accordance with the method 2. FIG. 12 illustrates the list of the physical servers PM held in the racks R1 to R3. The physical servers PM held by the racks R1 and R2 are as illustrated in FIG. 11, and the rack R3 holds physical servers PM3-1 to PM3-20.

In the method 2, the measurement virtual machines VM deployed in the physical servers PM held in adjacent racks are considered as a plurality of the physical servers PM with the same network device that the physical servers PM connect to. That is, according to the method 2, the plurality of physical servers PM for which the connecting network device is the same include a plurality of the physical servers PM for which the racks (holding devices) holding the physical servers PM are adjacent.

Accordingly, the method execution module 132 is able to deploy the measurement virtual machines VM in the physical servers PM with a high possibility of sharing the same LAN cable 200. Therefore, the method execution module 132 is able to identify the sharing relationship efficiently.

According to the example of FIG. 12, the method execution module 132 deploys the measurement virtual machine VM preferentially to, for example, the physical servers PM1-1 to PM3-20 held in the adjacent racks R1 to R3. The method execution module 132 deploys the measurement virtual machines VM in order from the physical servers PM in the adjacent racks R1 to R3 of which the positions within the rack are close to each other (as illustrated by an arrow RY).

The physical servers PM of which the positions within the rack are close are, for example, a combination of the physical servers PM1-1, PM2-1, and PM3-1, a combination of the physical server PM1-2, PM2-2, and PM3-2, and the like.

The method execution module 132 deploys the measurement virtual machines VM in the physical servers PM1-1 to PM1-4, PM2-1 to PM2-4, and PM3-1 to PM3-4, as illustrated by a dotted rectangle y1 in FIG. 12. As illustrated in FIG. 12, the method execution module 132 deploys the fluctuating-load virtual machine VM2-1A and the steady-load virtual machines VM1-1A to VM3-4.

As illustrated by a dotted rectangle y2, the method execution module 132 upon the second round of the deployment and identification deploys the measurement virtual machines VM with respect to the physical server PM1-5 to PM3-9. It is also similar for the third round of the deployment and thereafter.

Next, with reference to FIGS. 13 to 21, the details of the processing of a case of performing the processing of step S33 in FIG. 10 will be described. In step S33, the method execution module 132 performs one round of the deployment and identification of the measurement virtual machine VM, in accordance with the selected method.

(Step S33 in FIG. 10 with Method 1)

FIG. 13 is a flowchart diagram illustrating the processing of step S33 in FIG. 10 in accordance with the method 1.

S41: The method execution module 132 creates a plan to deploy the measurement virtual machines VM such that there is a one-to-one relationship between the storage pool SP and the measurement virtual machine VM. That is, in the case where one physical server PM includes two storage pools SP, the method execution module 132 creates a plan to deploy two virtual machines VM in the physical server PM.

S42: In accordance with the method 1, the method execution module 132 selects the physical server PM in which the measurement virtual machine VM is intended to be deployed. For example, in the case where the number of the selected measurement virtual machines VM does not reach the number of the load-applying virtual machines, the method execution module 132 selects the physical server PM within a different rack. As described above with FIG. 11, the method execution module 132 selects, for example, the physical servers PM1-1 to PM1-14.

S43: The method execution module 132 instructs the measurement virtual machine deployment module 134 to deploy the fluctuating-load virtual machine VM and the steady-load virtual machine VM with respect to the selected physical server PM. In response to the instruction, the measurement virtual machine deployment module 134 performs the deployment of the measurement virtual machine VM and the installation of the tool. Accordingly, the fluctuating-load virtual machine VM1-1A and the steady-load virtual machines VM1-1B to VM1-14 are deployed.

(Step S43 in FIG. 13)

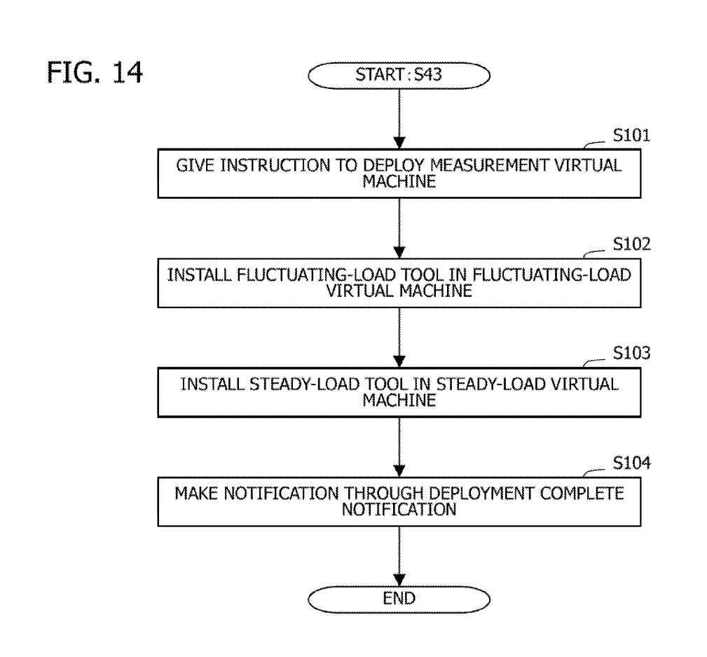

FIG. 14 is a flowchart diagram illustrating the processing of step S43 in FIG. 13

S101: In response to the instruction, the measurement virtual machine deployment module 134 deploys the measurement virtual machine VM in the selected physical server PM.

S102: The measurement virtual machine deployment module 134 installs the fluctuating-load tool 150a with respect to the virtual machine VM1-1A deployed in the physical server PM in which the fluctuating-load virtual machine VM is to be deployed.

S103: The measurement virtual machine deployment module 134 installs the steady-load tool 150b with respect to the respective virtual machines VM1-1B to VM1-14 deployed in the physical server PM in which the steady-load virtual machine VM is to be deployed.

S104: The measurement virtual machine deployment module 134 makes a notification through a deployment complete notification with respect to the method execution module 132. Return to the flowchart diagram in FIG. 13.

S44: When the deployment of the measurement virtual machine VM (in step S43) is complete, the load setting module 133 sets the value of the access load with respect to the fluctuating-load tool 150a or the steady-load tool 150b that runs on the measurement virtual machine VM. The load setting module 133 gives an instruction to start the fluctuating-load tool 150a or the steady-load tool 150b and to start the load measurement modules 151a and 151b.

Accordingly, in each measurement virtual machine VM, the throughput of the access processing in the time period of applying the access load is measured in accordance with the load measurement modules 151a and 151b.

S45: With the measured-value collection module 131, the measurement results of the throughput are collected from the respective measurement virtual machines VM and stored in a measured-load-value table 122-1.

(Measured-Load-Value Table 122-1)

FIG. 15 is a diagram illustrating an example of the measured-load-value table 122-1. In the measured-load-value table 122-1 in FIG. 15, the measurement results of the fluctuating-load virtual machine VM1-1A and the steady-load virtual machines VM1-1B and VM1-2A are excerpted and represented.

As illustrated in FIG. 15, the measured-load-value table 122-1 includes information of the rack holding the physical server PM in which the measurement virtual machine VM is deployed and the measured values of the throughput (MB/S) over time. In the example of FIG. 15, the measured-load-value table 122-1 includes the measured values for each minute. That is, times 1 to n are times for each minute.

According to the example of FIG. 15, the measured value of the fluctuating-load virtual machine VM1-1A fluctuates between a value of 70 MB and a value of 0 MB, and the measured value of the steady-load virtual machine VM1-1B fluctuates between a value of 50 MB and a value of 100 MB. The measured value of the steady-load virtual machine VM1-2A is a steady value of 100 MB.

S46: The method execution module 132 identifies the fluctuating-load virtual machine VM and the steady-load virtual machine VM that share the same LAN cable 200, on the basis of the measured-load-value table 122-1. The method execution module 132 stores the identified sharing relationship in the shared-bandwidth management table 121.

(Identification of Sharing Relationship)

Specifically, the method execution module 132 identifies the combination of the steady- and fluctuating-load virtual machines VM that share the same LAN cable 200, on the basis of the correlation of a first measurement result of the steady-load virtual machine VM and a second measurement result of the fluctuating-load virtual machine VM.

As described above with FIGS. 4 to 6, the measured values of the steady-load virtual machine VM and the fluctuating-load virtual machine VM that share the same LAN cable 200 have a correlation. Thus, the method execution module 132 is able to easily and appropriately identify the measurement virtual machines VM that share the same LAN cable 200, on the basis of the correlation of the first and second measurement results.

More specifically, the method execution module 132 calculates the similarity in accordance with an expression 2 below and determines the presence or absence of a correlation on the basis of the similarity. The “reverse value of measured value of fluctuating-load virtual machine VM” in the expression 2 indicates the opposite result of the measurement result of the fluctuating-load virtual machine VM. For example, the “reverse value of measured value of fluctuating-load virtual machine VM” is the difference between the measured value measured when the maximum access load is applied and the measured value of the fluctuating-load virtual machine VM.

In this embodiment, the measured value measured for a case where the maximum access load has been applied is a value of 100 MB. The measured value is calculated on the basis of, for example, 25 as the number of the load-applying virtual machines, 4 as the coefficient, and 1 Gbps as the bandwidth that the LAN cable 200 is able to use.

Similarity=cosine(reverse value of measured value of fluctuating-load virtual machine VM, measured value of steady-load virtual machine VM). Expression 2:

The similarity indicates the proximity for the angle between the vector “reverse value of measured value of fluctuating-load virtual machine VM” and the vector “measured value of steady-load virtual machine VM.” A higher similarity of the vectors give a value closer to 1. Thus, the method execution module 132 identifies the combination of the fluctuating-load virtual machine VM and the steady-load virtual machine VM with which the calculated similarity is greater than or equal to a predetermined value, as the measurement virtual machines VM that share the same LAN cable 200. The similarity for the expression 2 may be calculated in accordance with the reverse value of the measured value of the steady-load virtual machine VM and the measured value of the fluctuating-load virtual machine VM.

In this manner, the method execution module 132 calculates the correlation value for the difference between the measurement result of a case where the maximum access load has been applied and the first measurement result of the steady-load virtual machine VM and the second measurement result of the fluctuating-load virtual machine VM. Alternatively, the method execution module 132 calculates the correlation value for the difference between the measurement result of a case where the maximum access load has been applied and the second measurement result of the fluctuating-load virtual machine VM and the first measurement result of the fluctuating-load virtual machine VM. The method execution module 132 identifies the combination of the steady-load virtual machine VM and the fluctuating-load virtual machine VM for which the correlation value exceeds a predetermined value.

In this manner, it is possible to appropriately determine the presence or absence of a correlation in the measurement results, on the basis of the correlation value indicating the similarity of the reverse value of the measurement result of one and the measurement result of the other of the steady- and fluctuating-load virtual machines VM. Thus, the method execution module 132 is able to appropriately identify the combination of the steady-load virtual machine VM and the fluctuating-load virtual machine VM having a correlation in the measurement results.

The method of calculating the correlation value of the measurement results is not limited to the example in the expression 2. For example, the method execution module 132 may calculate the correlation value in accordance with the inverse Fourier transformation or other methods of calculating the similarity.

The method execution module 132 may determine that the sharing relationship with another measurement virtual machine VM is not present, in the case where the difference in the measured values for the respective times of the measurement results of the steady-load virtual machine is at a value of 0 or within a predetermined error range. The method execution module 132 may identify the combination of the measurement virtual machines VM for which the total of the measurement results coincides with or is close to the maximum bandwidth of the LAN cable 200, as the measurement virtual machines VM that share the same LAN cable 200.

(Step S46 in FIG. 13)

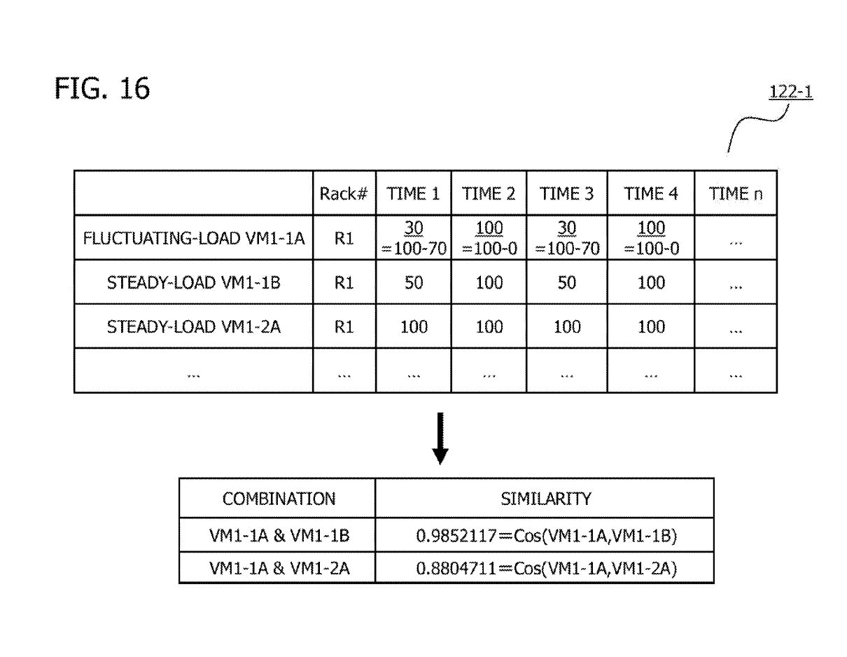

FIG. 16 is a diagram illustrating a calculation example for the similarity. FIG. 16 illustrates the reverse value of the measured value of the fluctuating-load virtual machine VM1-1A. The method execution module 132 calculates, as the reverse value, the difference between 100 MB as the maximum value of the measured value and the measured value. Thus, the reverse value for a time 1 is a value of 30 MB (=100−70). The reverse values are calculated in a similar manner for other times as well.

The method execution module 132 calculates that the similarity is 0.9852117, on the basis of the reverse value of the measurement result of the fluctuating-load virtual machine VM1-1A and the measurement result of the steady-load virtual machine VM1-1B, in accordance with the expression 2 described above. In a similar manner, the method execution module 132 calculates that the similarity is 0.8804711, on the basis of the reverse value of the measurement result of the fluctuating-load virtual machine VM1-1A and the measurement result of the steady-load virtual machine VM1-2A.

The method execution module 132 identifies that a plurality of the measurement virtual machines VM share the same LAN cable 200, in the case where the similarity exceeds a predetermined value of 0.9, for example. The predetermined value is set in accordance with a test or the like. According to the example of FIG. 16, the method execution module 132 identifies the fluctuating-load virtual machine VM1-1A and the steady-load virtual machine VM1-1B as the measurement virtual machines VM that share the same LAN cable 200.

(Shared-Bandwidth Management Table 121-1)

FIG. 17 is a diagram illustrating an example of a shared-bandwidth management table 121-1 created in step S46 of FIG. 13. As illustrated in FIG. 17, the shared-bandwidth management table 121-1 includes a sharing identification (ID), a rack ID, a physical server ID, and a virtual machine ID.

The sharing ID is an identifier of the sharing group. The rack ID is an identifier of the rack holding the physical server PM, and the physical server ID is an identifier of the physical server PM in which the measurement virtual machine VM is deployed. The virtual machine ID is an identifier of the measurement virtual machine VM.

As illustrated in the shared-bandwidth management table 121-1, the sharing group with a sharing ID of 1 includes information of the measurement virtual machines VM1-1A and VM1-1B. The shared-bandwidth management table 121-1 includes information of the physical servers PM in which the virtual machines VM1-1A and VM1-1B are deployed and information of the racks.

Next, the details of the processing in the case of performing the processing of step S33 in FIG. 10 on the basis of the method 2 will be described.

(Step S33 in FIG. 10 with Method 2)

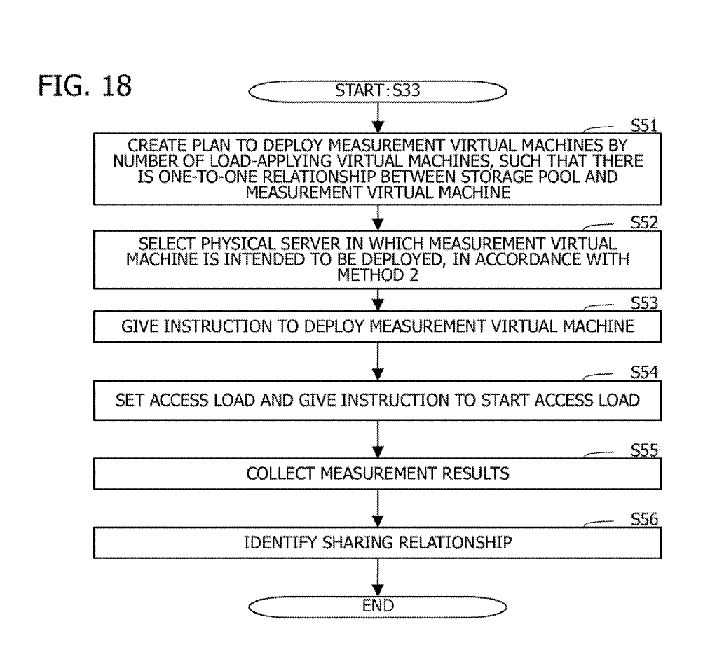

FIG. 18 is a flowchart diagram illustrating the processing of step S33 in FIG. 10 in accordance with the method 2. The processing of steps S51 and S53 to S56 is similar to that of steps S41 and S43 to S46 in FIG. 13, and therefore description will be omitted.

S52: In accordance with the method 2, the method execution module 132 selects the physical server PM in which the measurement virtual machine VM is intended to be deployed. As described above with FIG. 12, the method execution module 132 selects, for example, the physical servers PM1-1 to PM1-4, PM2-1 to PM2-4, and PM3-1 to PM3-4.

(Measured-Load-Value Table 122-2)

FIG. 19 is a diagram illustrating an example of a measured-load-value table 122-2 created in step S55. In the measured-load-value table 122-2 in FIG. 19, the measurement results of the fluctuating-load virtual machine VM2-1A and the steady-load virtual machines VM1-1A and VM3-1 are excerpted and represented.

According to the example of FIG. 19, the measured value of the fluctuating-load virtual machine VM2-1A fluctuates between a value of 30 MB and a value of 90 MB, and the measured value of the steady-load virtual machine VM1-1A fluctuates between a value of 5 MB and a value of 30 MB. The measured value of the steady-load virtual machine VM3-1 is a steady value of 100 MB.

(Step S46 in FIG. 13)

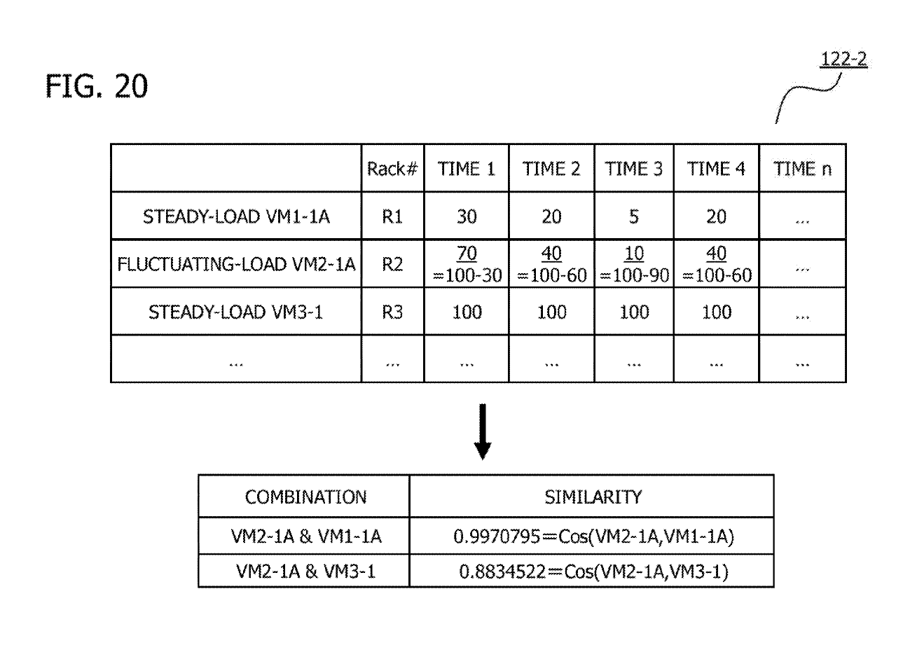

FIG. 20 is a diagram illustrating a calculation example for the similarity. FIG. 19 illustrates the reverse value of the measured value of the fluctuating-load virtual machine VM2-1A. As described above, the method execution module 132 calculates, as the reverse value, the difference between 100 MB as the maximum value of the measured value and the measured value. Thus, the reverse value for the time 1 is a value of 70 MB (=100−30). The reverse values are calculated in a similar manner for other times as well.

The method execution module 132 calculates that the similarity is 0.9970795, on the basis of the reverse value of the measurement result of the fluctuating-load virtual machine VM2-1A and the measurement result of the steady-load virtual machine VM1-1A. In a similar manner, the method execution module 132 calculates that the similarity is 0.8834522, on the basis of the reverse value of the measurement result of the fluctuating-load virtual machine VM2-1A and the measurement result of the steady-load virtual machine VM3-1.

According to the example of FIG. 20, the method execution module 132 identifies the fluctuating-load virtual machine VM2-1A and the steady-load virtual machine VM1-1A as the measurement virtual machines VM that share the same LAN cable 200.

(Shared-Bandwidth Management Table 121-2)

FIG. 21 is a diagram illustrating an example of a shared-bandwidth management table 121-2 created in step S56 of FIG. 18. As illustrated in the shared-bandwidth management table 121-2, the sharing group with the sharing ID of 1 includes information of the measurement virtual machines VM1-1A and VM2-1A that share the same LAN cable 200.

The processing of step S21 in FIG. 9 has been described with reference to FIGS. 10 to 21. Next, the processing of steps S22 to S25 in FIG. 9 will be described with reference to FIGS. 22 to 30.

### Step S22 in FIG. 9

FIG. 22 is a flowchart diagram illustrating the processing of step S22 in FIG. 9. As described above, in step S22, the deployment and identification are performed thoroughly with respect to the remaining physical servers PM in accordance with the determined method order. That is, in step S22, the deployment and identification intended for the physical servers PM not held in the racks R1 to R3 are performed.

S61: The method execution module 132 selects a method at a higher rank. In this embodiment, the method execution module 132 first selects the method 1 that is at a high rank.

S62: In accordance with the selected method, the method execution module 132 performs the deployment and identification. The deployment and identification are as described for step S33 in FIG. 10. The method execution module 132 performs the deployment and identification intended for the physical server PM for which the deployment and identification have not been performed in step S21.

S63: In the case where a new sharing relationship has been identified in step S62, the method execution module 132 determines whether or not the measurement virtual machine VM for which the sharing relationship is newly identified is included in the sharing group that has been already identified.

S64: With the method execution module 132, in the case of the virtual machine VM being included (Yes in step S63), information is added to the existing sharing group and joined with the shared-bandwidth management table 121. Specifically, the method execution module 132 adds information of the sharing relationship that has been newly identified to the existing sharing group.

S65: With the method execution module 132, in the case of the virtual machine VM not being included (No in step S63), a new sharing group is created and joined with the shared-bandwidth management table 121. Specifically, the method execution module 132 adds information of the new sharing relationship in the new sharing group of the shared-bandwidth management table 121.

S66: In accordance with the selected method, the method execution module 132 determines whether or not the deployment and identification have been performed thoroughly with respect to all of the physical servers PM. In the case of a negative (No in step S66), the method execution module 132 moves on to the processing in step S62.

S67: In the case of the deployment and identification having been performed thoroughly (Yes in step S66), the method execution module 132 determines whether or not the executions have been done in accordance with all of the methods. In the case of the executions having been done in accordance with all of the methods (Yes in step S67), the method execution module 132 terminates the processing in step S22.

S68: In the case of a negative (No in step S67), the method execution module 132 selects a different method and moves on to the processing in step S62.

(Steps S64 and S65)

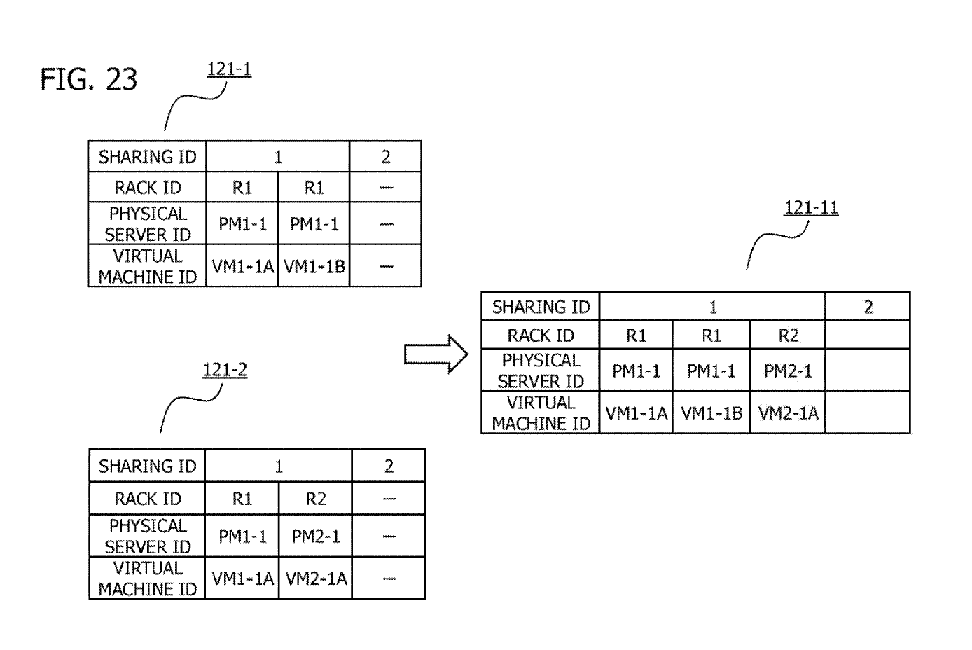

FIG. 23 is a diagram illustrating an example of the processing in step S64. In FIG. 23, the two shared-bandwidth management tables 121-1 and 121-2 are illustrated an example.

The shared-bandwidth management table 121-1 includes information of an already-identified first sharing group including the sharing relationship of the measurement virtual machine VM1-1A and VM1-1B. The shared-bandwidth management table 121-2 includes information of a newly-identified second sharing group including the sharing relationship of the measurement virtual machine VM1-1A and VM2-1A.

With the example of FIG. 23 (for Yes in step S63), there is an overlap of the measurement virtual machine VM1-1A between the first and second sharing groups. That is, the example of FIG. 23 illustrates a case where the measurement virtual machine VM within the second sharing group for which the sharing relationship is newly identified is included in the first sharing group. Thus, a shared-bandwidth management table 121-11 includes information of the sharing group in which the first and second sharing groups are joined.

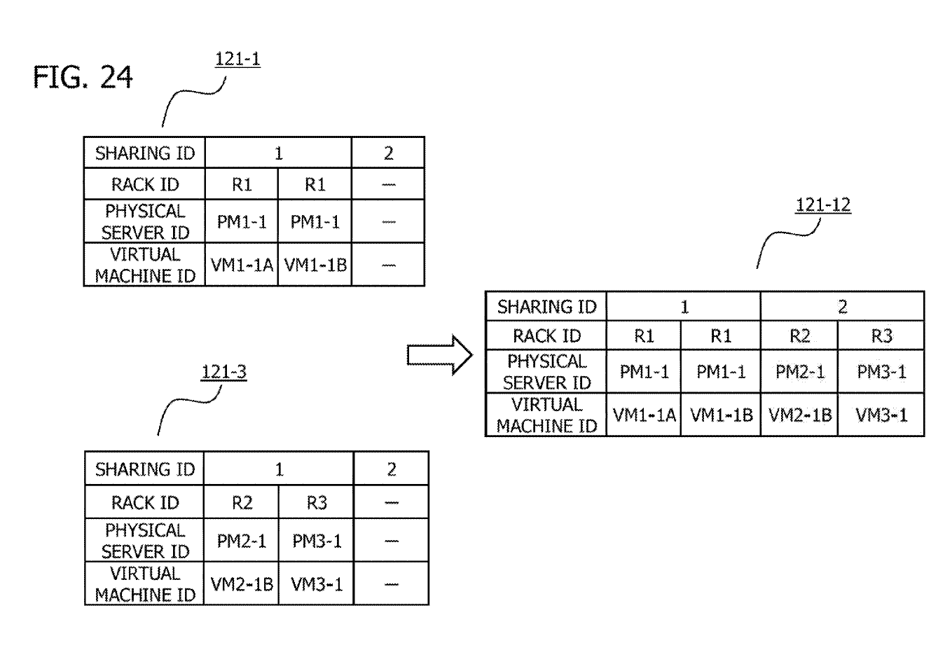

FIG. 24 is a diagram illustrating an example of the processing in step S65. In FIG. 24, two shared-bandwidth management tables 121-1 and 121-3 are illustrated an example.

The shared-bandwidth management table 121-1 includes information of the first sharing group in a similar manner to the shared-bandwidth management table 121-1 illustrated in FIG. 23. The shared-bandwidth management table 121-3 includes information of a newly-identified third sharing group including the sharing relationship of the measurement virtual machine VM2-1B and VM3-1.

With the example of FIG. 24 (for No in step S63), the measurement virtual machine VM with an overlap of the sharing relationship between the first and third sharing groups does not exist. Thus, a shared-bandwidth management table 121-12 includes information of the first and third sharing groups separately.

### Step S23 in FIG. 9

FIG. 25 is a flowchart diagram illustrating the processing of step S23 in FIG. 9. As described above, in step S23, the re-deployment and identification intended for the measurement virtual machine VM for which the sharing relationship is not identified are performed. That is, the method execution module 132 performs the re-deployment and identification of the measurement virtual machine VM, intended for the measurement virtual machine VM of which the sharing relationship is yet to be identified even with the deployment and identification (in steps S21 and S22) having been performed in accordance with the method.

S71: The method execution module 132 selects the sharing groups in correspondence with the number of the load-applying virtual machines from the sharing groups to which a single measurement virtual machine VM belongs. The method execution module 132 selects the measurement virtual machine VM of the selected sharing group and selects the measurement virtual machines VM in correspondence with the number of the load-applying virtual machines.

S72: The method execution module 132 selects one out of the selected measurement virtual machines VM as the fluctuating-load virtual machine VM and the others as the steady-load virtual machines VM. The method execution module 132 performs the re-deployment and identification. The deployment and identification are as described for steps S43 to S46 in FIG. 13 (and similarly for steps S53 to S56 in FIG. 18).

S73: With the method execution module 132, in the case where a new sharing relationship has been identified in accordance with step S72, the sharing groups are joined and stored in the shared-bandwidth management table 121. Specifically, the method execution module 132 integrates the sharing relationship into the sharing group with a smaller value of the sharing ID, between the sharing groups for which the sharing relationship is identified.

S74: The method execution module 132 determines whether or not the processing of steps S72 and S73 has been performed for all of the combinations of the sharing groups to which a single measurement virtual machine VM belongs.

S75: In the case of a negative (No in step S74), the method execution module 132 selects the sharing group to which a single measurement virtual machine VM belongs and for which the determination is yet to be performed and selects the measurement virtual machine VM. The method execution module 132 moves on to the processing of step S72. In the case of a positive (Yes in step S74), the method execution module 132 terminates the processing of step S23.

(Processing Flow of Step S23)

FIG. 26 is a diagram schematically illustrating the processing of step S23, described with the flowchart diagram in FIG. 25. FIG. 26 illustrates an example of the change over time with sharing group sets T11 to T13.

According to the first sharing group set T11, sharing groups ID10 to ID13 include single measurement virtual machines VM7-1A, VM8-1A, and VM9-1A. Thus, the method execution module 132 selects the measurement virtual machines VM7-1A, VM8-1A, and VM9-1A (in step S71 of FIG. 25). The method execution module 132 performs the re-deployment and identification (in step S72).

In the example of FIG. 26, the sharing relationship of the measurement virtual machines VM7-1A and VM8-1A is identified. Thus, as illustrated in the second sharing group set T12, the method execution module 132 integrates the sharing group ID11 into the sharing group ID10 with a smaller value of the sharing ID (in step S73). As illustrated in the third sharing group set T13, the method execution module 132 changes the sharing group ID12 to the sharing group ID11.

In this manner, with the method execution module 132, a plurality of the measurement virtual machines VM not included in a plurality of the identified measurement virtual machines VM are selected, and the re-deployment, in each physical server PM in which each selected measurement virtual machine VM has been deployed, and identification of the first or second measurement virtual machine VM are performed. Accordingly, the method execution module 132 is able to efficiently identify the sharing relationship that has not been identifiable with the method.

### Step S24 in FIG. 9

FIG. 27 is a flowchart diagram illustrating the processing of step S24 in FIG. 9. As described above, in step S24, the sharing relationship between the identified sharing groups is identified.

S81: The method execution module 132 selects the sharing groups in correspondence with the number of the load-applying virtual machines from the sharing groups that include a plurality of the measurement virtual machines VM. The method execution module 132 selects one measurement virtual machine VM from each of the selected sharing groups. Accordingly, the measurement virtual machines VM in correspondence with the number of the load-applying virtual machines are selected.

The processing of steps S82 and S83 is similar to the processing of steps S72 and S73 in FIG. 25.

S84: The method execution module 132 determines whether or not the processing of steps S82 and S83 has been performed for all of the combinations of the sharing groups including a plurality of the measurement virtual machines VM.

S85: In the case of a negative (No in step S84), the method execution module 132 selects the sharing groups that include a plurality of the measurement virtual machines VM and for which the determination is yet to be performed and selects the measurement virtual machine VM. The method execution module 132 moves on to the processing of step S82. In the case of a positive (Yes in step S84), the method execution module 132 terminates the processing of step S24.

(Processing Flow of Step S24)

FIG. 28 is a diagram schematically illustrating the processing of step S24, described with the flowchart diagram in FIG. 27. FIG. 28 illustrates an example of the change over time with sharing group sets T21 to T24.

According to the first sharing group set T21, sharing groups ID1 to ID3 each include a plurality of the measurement virtual machines. The method execution module 132 selects the sharing groups ID1 to ID3, and selects measurement virtual machines VM2-1A, VM3-1A, and VM4-11A as ones representing the plurality of measurement virtual machines VM included in the sharing groups (in step S81 of FIG. 27). The method execution module 132 performs the re-deployment and identification (in step S82).

In the example of FIG. 28, the sharing relationship of the measurement virtual machines VM2-1A and VM3-1A is identified. Thus, as illustrated in the second sharing group set T22, the method execution module 132 integrates the sharing group ID2 into the sharing group ID1 with a smaller value of the sharing ID (in step S83).

As illustrated in the third sharing group set T23, the method execution module 132 changes sharing groups ID3 to ID5 to sharing groups ID2 to ID4. As illustrated in the fourth sharing group set T24, the method execution module 132 selects the sharing groups ID3 and ID4 that have been yet to be selected, in addition to the sharing group ID1, and performs the re-deployment and identification (in steps S81 and S82).

In this manner, the method execution module 132 selects one virtual machine VM from each of respective measurement virtual machine VM sets each including a plurality of the identified measurement virtual machines VM. The method execution module 132 performs the re-deployment, in each physical server PM in which each selected measurement virtual machine VM has been deployed, and identification of the first virtual machine VM or the second measurement virtual machine VM.

In this manner, by identifying the sharing relationship between the sharing groups, the method execution module 132 is able to identify the virtual machines VM that share the same LAN cable 200 more efficiently. Since the measurement virtual machines except for one out of the sharing group are able to be excluded from those intended for the next round of the deployment and thereafter, it is possible to reduce the number of rounds of the deployment and identification.

### Step S25 in FIG. 9

FIG. 29 is a flowchart diagram illustrating the details of the processing of step S25 in FIG. 9. As described above, in step S25, the destination of the deployment of the demanded virtual machine for which the deployment has been demanded by the user is determined on the basis of information of the identified sharing group.

S91: The method execution module 132 references the shared-bandwidth management table 121 and selects the sharing group having an available bandwidth out of the sharing groups. The method execution module 132 calculates the available bandwidth in accordance with an expression 3 below.

Available bandwidth=bandwidth that physical path is able to use−sum of already-allocated guaranteed bandwidth of sharing group. Expression 3:

For example, the method execution module 132 acquires the “bandwidth that physical path is able to use” corresponding to the sharing group. For example, the method execution module 132 acquires the bandwidth that the physical path is able to use, on the basis of the measurement result.

S92: The method execution module 132 determines whether or not a sharing group with an available bandwidth to which the demanded bandwidth demanded by the user is allocatable is present for the demanded virtual machine. In the case of the sharing group being absent (No in step S92), the method execution module 132 makes a notification through a message that the demanded bandwidth is not able to be reliably provided and terminates the processing.

S93: In the case of the sharing group being present (Yes in step S92), the method execution module 132 selects, out of the physical servers PM belonging to the sharing group, the physical server PM with a small number of the deployed demanded virtual machines and with a small bandwidth that has already been allocated to the storage pool SP.

S94: With the method execution module 132, information of the ID of the demanded virtual machine and the demanded bandwidth of the demanded virtual machine is registered in the shared-bandwidth management table 121.

(Processing Flow of Step S25)

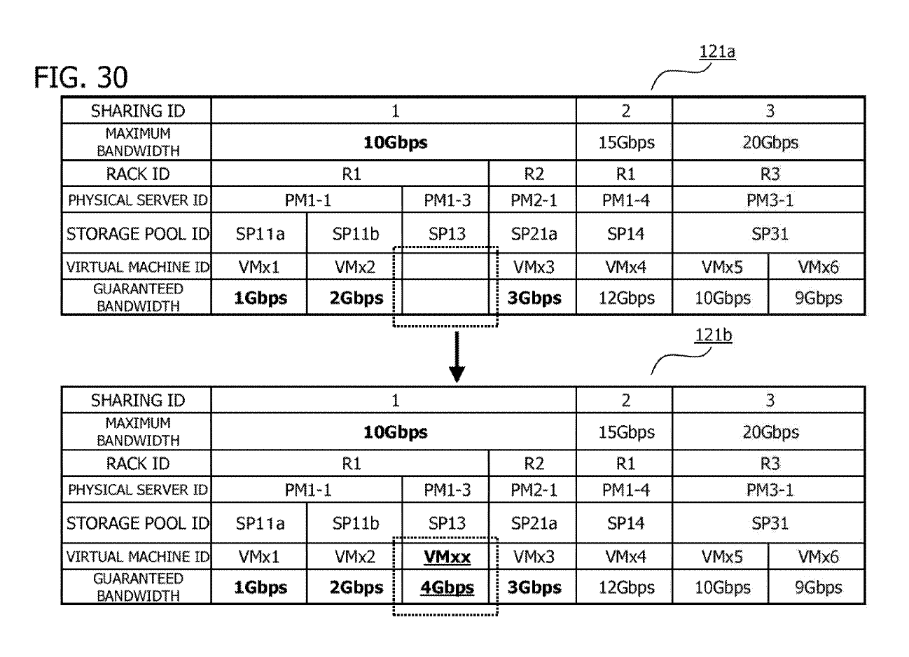

FIG. 30 is a diagram schematically illustrating the processing of step S25. FIG. 30 illustrates an example of shared-bandwidth management tables 121a and 121b after the processing of step S25. Relative to the shared-bandwidth management tables 121-1 and 121-2 described with FIGS. 17 and 21, the shared-bandwidth management tables 121a and 121b illustrated in FIG. 30 further include information of the bandwidth of the physical path, the ID of the storage pool SP, and the guaranteed bandwidth of the demanded virtual machine.

The shared-bandwidth management table 121a in FIG. 30 illustrates an example of a case where demanded virtual machines VMx1 to VMx6 of which the deployment has been demanded by the user have already been deployed and where further a demanded virtual machine VMxx is to be deployed. For this example, an example is illustrated of a case where the guaranteed bandwidth of the demanded virtual machine VMxx is 4 Gbps.

According to the shared-bandwidth management table 121a, the bandwidth of the LAN cable 200 is 10 Gbps for the sharing group ID1, while the total of the bandwidths that have already been allocated is at a value of 6 Gbps (=1+2+3). Thus, the available bandwidth of the sharing group ID1 is at a value of 4 Gbps (=10−6). The available bandwidth of the sharing group ID2 is at a value of 3 Gbps, and the available bandwidth of the sharing group ID3 is at a value of 1 Gbps.

Thus, the group that is able to reliably provide the guaranteed bandwidth of 4 Gbps is the sharing group ID1. Out of the physical servers PM belonging to the sharing group ID1, the physical server PM1-3 is without a demanded virtual machine VM deployed and without a bandwidth that has already been allocated to a storage pool SP13. Thus, the method execution module 132 determines that the demanded virtual machine VMxx is to be deployed in the physical server PM1-3.

The method execution module 132 stores information of the ID “VMxx” and the demanded bandwidth of 4 Gbps of the demanded virtual machine in the item for the physical server PM1-3 in the shared-bandwidth management table 121b.

### Increasing Efficiency of Identification of Sharing Relationship

With the network evaluation program 120 in this embodiment, as described for step S24, it is possible to exclude the steady-load virtual machine VM for which the sharing relationship with the fluctuating-load virtual machine VM has been identified, from those intended for the next round of the deployment and thereafter. Accordingly, it is possible to reduce the number of rounds of the deployment and identification, and it is possible to reduce the number of actions taken for the identification of the sharing relationship.

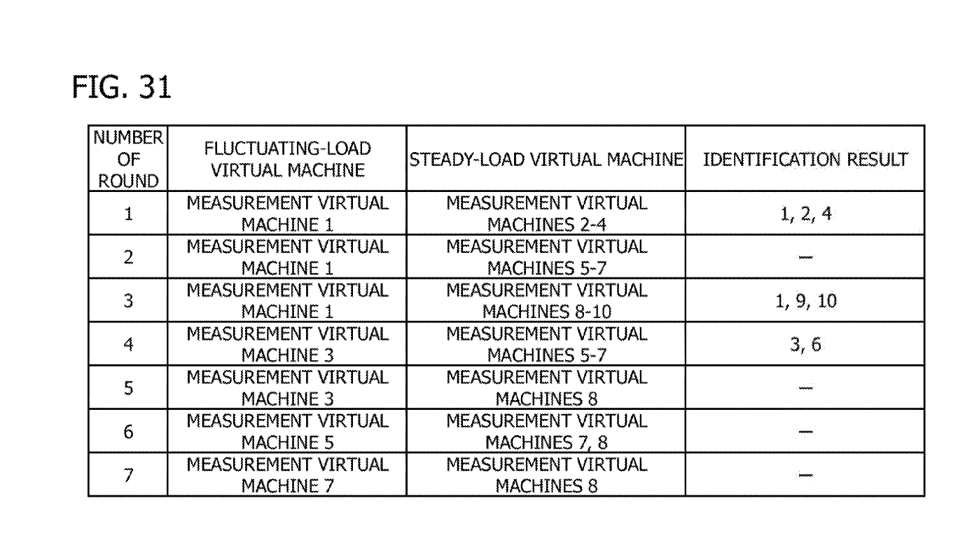

FIG. 31 is a diagram illustrating the number of actions taken for the identification of the sharing relationship. FIG. 31 illustrates an example of a case of identifying the sharing relationship of 10 measurement virtual machines VM, the case being such that four measurement virtual machines VM are deployed in one round of the deployment and identification. For example, in the case of determining the sharing relationships of the 10 measurement virtual machines VM by brute force, for four at a time, there are 210 combinations (=combination (10, 4)) for the determination. In contrast, with the network evaluation program 120 of this embodiment, it is possible to identify the sharing relationships in seven rounds of the deployment and identification.

As illustrated in FIG. 31, in the first round, the deployment and identification of a fluctuating-load virtual machine 1 and steady-load virtual machines 2 to 4 are performed. In the second round, steady-load virtual machines 5 to 7 that have been yet to be deployed, in addition to the fluctuating-load virtual machine 1, are deployed. In the third round, steady-load virtual machines 8 to 10 that have been yet to be deployed, in addition to the fluctuating-load virtual machine 1, are deployed. Accordingly, a sharing group (of 1, 2, 4, 9, and 10) is identified.

In the fourth round, a fluctuating-load virtual machine 3 and the steady-load virtual machines 5 to 7 for which the sharing relationship is yet to be identified are deployed, and a sharing group (of 3 and 6) is identified. In a similar manner, in the fifth round, the fluctuating-load virtual machine 3 and the steady-load virtual machine 8 for which the sharing relationship is yet to be identified are deployed, and the identification is performed. In the sixth round, a fluctuating-load virtual machine 5 and the steady-load virtual machines 7 and 8 for which the sharing relationship is yet to be identified are deployed, and the identification is performed. In the seventh round, a fluctuating-load virtual machine 7 and the steady-load virtual machine 8 for which the sharing relationship is yet to be identified are deployed, and the identification is performed.

Accordingly, sharing groups of “1, 2, 4, 9, and 10,” “3 and 6,” “5,” “7,” and “8” are identified. In this manner, by executing the seven rounds of the deployment and identification, the network evaluation program 120 is able to reduce the number of rounds of the deployment and identification and reduce the number of actions taken for the identification of the sharing relationship, relative to the 210 combinations of the case where the identification is done through brute force.

### Different Embodiment

In the embodiment described above, a case has been illustrated as an example where one measurement virtual machine VM out of the plurality of measurement virtual machines VM is the fluctuating-load virtual machine VM. Note that the method execution module 132 may deploy two or more of the fluctuating-load virtual machines VM. By increasing the number of the fluctuating-load virtual machines VM, it is possible to identify more sharing relationships in one round of the deployment and identification.

In the case of deploying a plurality of the fluctuating-load virtual machines VM, the method execution module 132 causes the fluctuation cycles of the access load of the plurality of fluctuating-load virtual machines VM to be different. That is, the method execution module 132 identifies a plurality of the virtual machines VM that share the same physical path, on the basis of the measurement results for a case where one or more of the first virtual machines VM and a plurality of the second virtual machines VM with the different fluctuation cycles of the access load have been executed.

In this manner, with the fluctuation cycles being different, the method execution module 132 is able to identify the fluctuating-load virtual machine VM having a correlation with the steady-load virtual machine VM in the measurement results. Accordingly, in the case where the steady-load virtual machine VM has a sharing relationship with any of the plurality of fluctuating-load virtual machines VM, it is possible to appropriately identify the combination of the steady-load virtual machine VM and the fluctuating-load virtual machine VM having the sharing relationship.

With the fluctuation cycles being different, it is possible to appropriately identify the presence or absence of the sharing relationship of the steady-load virtual machine VM with the plurality of fluctuating-load virtual machines VM, also in the case where the steady-load virtual machine VM has a sharing relationship with two of the plurality of fluctuating-load virtual machines VM.

### Example of Measurement Result

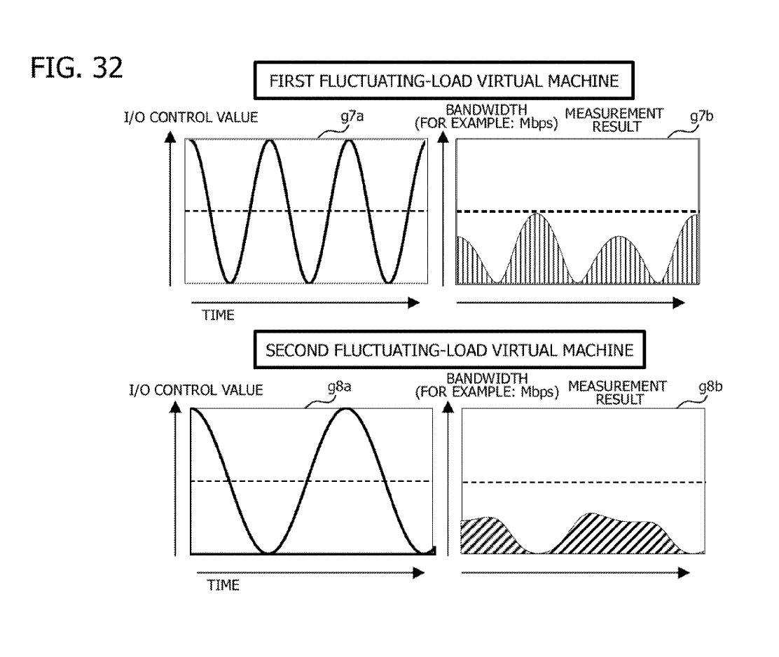

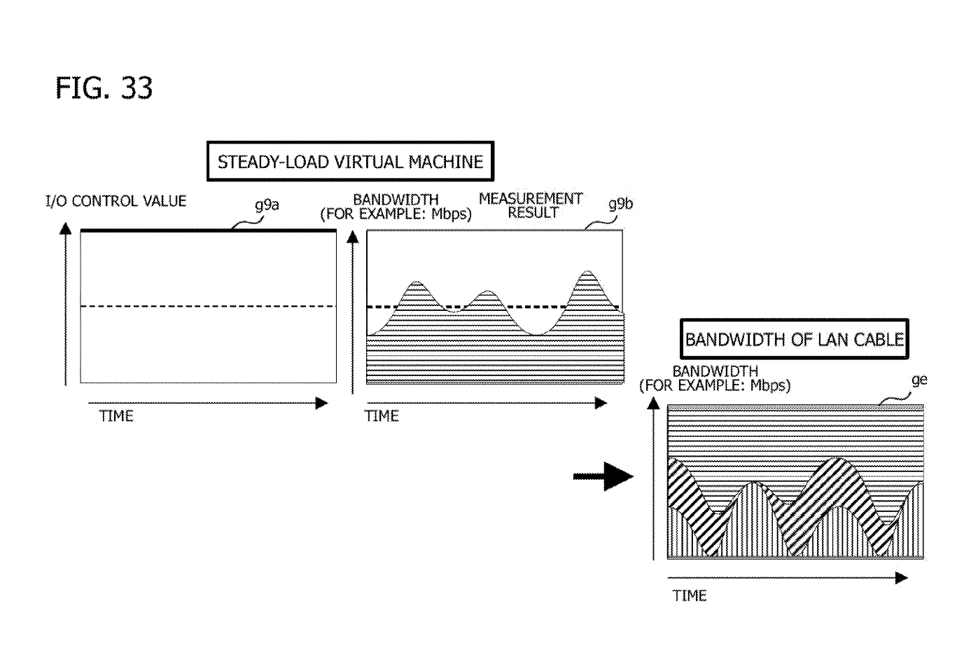

FIGS. 32 and 33 are diagrams illustrating an example of the measurement results for a case where two of the fluctuating-load virtual machines VM and the steady-load virtual machine VM share the same LAN cable 200.

FIG. 32 is a diagram illustrating an example of the access loads and the measurement results of the first and second fluctuating-load virtual machines VM.

A graph g7a in the upper left in FIG. 32 illustrates the change in the access load applied by the first fluctuating-load virtual machine VM, and a graph g7b illustrates the measured value of the first fluctuating-load virtual machine VM. A graph g8a in the lower left in FIG. 32 illustrates the change in the access load applied by the second fluctuating-load virtual machine VM, and a graph g8b illustrates the measured value of the second fluctuating-load virtual machine VM. As illustrated in the graphs g7a and g8a, the fluctuation cycles of the access loads applied by the first and second fluctuating-load virtual machines are different from each other.

FIG. 33 is a diagram illustrating an example of the access load and the measurement result of the steady-load virtual machine VM. A graph g9a in the upper left in FIG. 33 illustrates the change in the access load applied by the steady-load virtual machine VM, and a graph g9b illustrates the measured value of the steady-load virtual machine VM.

FIGS. 32 and 33 illustrate a case where the same LAN cable 200 is shared between the first and second fluctuating-load virtual machines VM and the steady-load virtual machine VM. Thus, the measured value of the steady-load virtual machine VM (in the graph g9b), being subject to the influence of the sum total of the access load applied by the first and second fluctuating-load virtual machines VM (in the graphs g7a and g8a), fluctuates.

The measured values of the first and second fluctuating-load virtual machines VM (in the graphs g7b and g8b), being subject to the influence of the total sum of the access load applied by the steady-load virtual machine VM and the other fluctuating-load virtual machine VM, fluctuate. As illustrated in a graph ge, the total of the measured values coincides with the maximum bandwidth of the LAN cable 200.

In this manner, the network evaluation program 120 is able to determine the sharing relationship of the steady-load virtual machine VM and a plurality of the fluctuating-load virtual machines VM, on the basis the correlation between the measurement result of the steady-load virtual machine VM and the total of the measurement results or each measurement result of the two fluctuating-load virtual machines VM.

While a case is illustrated as an example where each communication is made over one LAN cable 200 in this embodiment, this example is not limiting. It is effective also for a case where each communication is made over a plurality of the LAN cables 200.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing therein a network evaluation program for causing a computer to execute a process comprising:
deploying, in each physical machine of a system in which one or more physical machines and one or more physical storage devices are connected via a physical path, a first virtual machine to execute software of applying a steady access load with respect to the physical storage device or a second virtual machine to execute software of applying a fluctuating access load with respect to the physical storage device; and
identifying a plurality of the virtual machines that share a same physical path, based on a measurement result of throughput for a case where at least one or more of the second virtual machines and one or more of the first virtual machines have been executed in a same time period.

2. The non-transitory computer-readable storage medium according to claim 1, wherein, for the identifying, a combination of the first virtual machine and the second virtual machine that share the same physical path is identified, based on a correlation of a first measurement result of the first virtual machine and a second measurement result of the second virtual machine.

3. The non-transitory computer-readable storage medium according to claim 2, wherein, for the identifying, a correlation value for a difference between a measurement result of a case where a maximum access load has been applied and the first measurement result and the second measurement result or a correlation value for a difference between a measurement result of a case where the maximum access load has been applied and the second measurement result and the first measurement result is calculated, and a combination of the first virtual machine and the second virtual machine for which the correlation value exceeds a predetermined value is identified.

4. The non-transitory computer-readable storage medium according to claim 1, wherein the same physical path is a physical path in which a bandwidth is shared.

5. The non-transitory computer-readable storage medium according to claim 1, wherein the same physical path is a physical path including a cable.

6. The non-transitory computer-readable storage medium according to claim 1, wherein, for the identifying, in a case where a plurality of the second virtual machines have been deployed, a plurality of the virtual machines that share the same physical path are identified, based on the measurement result of a case where the one or more first virtual machines and the plurality of second virtual machines with different fluctuation cycles of the access load have been executed.

7. The non-transitory computer-readable storage medium according to claim 1, wherein, for the deploying, a total number of the first virtual machine and the second virtual machine to be deployed is calculated, based on a difference between a measured value of a case where a maximum access load has been applied with respect to the physical storage device and the maximum access load and on a bandwidth of the physical path.

8. The non-transitory computer-readable storage medium according to claim 1, wherein, for the deploying, the first virtual machine or the second virtual machine is deployed in, out of the respective physical machines, a plurality of the physical machines for which a network device that the physical machine connects to is same.

9. The non-transitory computer-readable storage medium according to claim 8, wherein the plurality of physical machines for which the connecting network device is same includes a plurality of the physical machines for which a holding device holding the physical machine is same.

10. The non-transitory computer-readable storage medium according to claim 8, wherein the plurality of physical machines for which the connecting network device is same includes a plurality of the physical machines for which holding devices holding the physical machines are adjacent.

11. The non-transitory computer-readable storage medium according to claim 1, wherein, for the deploying, the first virtual machine or the second virtual machine is deployed for each virtual storage device deployed in each of the physical machines.

12. The non-transitory computer-readable storage medium according to claim 1, wherein, further, one virtual machine is selected from each virtual machine set that each includes the plurality of identified virtual machines, the first virtual machine or the second virtual machine is re-deployed in each of the physical machines in which each selected virtual machine has been deployed, and the identifying is performed.

13. The non-transitory computer-readable storage medium according to claim 1, wherein, further, a plurality of the virtual machines not included in the plurality of identified virtual machines are selected, the first virtual machine or the second virtual machine is re-deployed in each of the physical machines in which each selected virtual machine has been deployed, and the identifying is performed.

14. A network evaluation method comprising:
deploying, in each physical machine of a system in which one or more physical machines and one or more physical storage devices are connected via a physical path, a first virtual machine to execute software of applying a steady access load with respect to the physical storage device or a second virtual machine to execute software of applying a fluctuating access load with respect to the physical storage device; and
identifying a plurality of the virtual machines that share a same physical path, based on a measurement result of throughput for a case where at least one or more of the second virtual machines and one or more of the first virtual machines have been executed in a same time period.

15. A network evaluation device comprising:
a deploying unit that deploys, in each physical machine of a system in which one or more physical machines and one or more physical storage devices are connected via a physical path, a first virtual machine to execute software of applying a steady access load with respect to the physical storage device or a second virtual machine to execute software of applying a fluctuating access load with respect to the physical storage device; and
an identifying unit that identifies a plurality of the virtual machines that share a same physical path, based on a measurement result of throughput for a case where at least one or more of the second virtual machines and one or more of the first virtual machines have been executed in a same time period.
